(19) United States
(12) Patent Application Publication
(10) Pub. No.: US 2022/0404668 A1
(43) Pub. Date: Dec. 22, 2022

(54) VIDEO PROCESSER AND DISPLAY DEVICE

(71) Applicant: SHARP KABUSHIKI KAISHA, Sakai City (JP)

(72) Inventor: TAKAYUKI MURAI, Sakai City (JP)

(21) Appl. No.: 17/835,638

(22) Filed: Jun. 8, 2022

Related U.S. Application Data
(60) Provisional application No. 63/213,639, filed on Jun. 22, 2021.

(51) Int. Cl. G02F 1/13357; G02F 1/1347

(52) U.S. Cl. CPC G02F 1/133603; G02F 1/1347; G02F 1/133611

(57) ABSTRACT

A video processer controls a display panel including a first liquid crystal panel, a second liquid crystal panel, and a backlight disposed facing one another, and includes a plurality of video processing units configured to control the first liquid crystal panel, the second liquid crystal panel, and the backlight. The plurality of video processing units control at least the first liquid crystal panel among the first liquid crystal panel, the second liquid crystal panel, and the backlight, by dividing the first liquid crystal panel into a plurality of sections. In a case where at least two units of the first liquid crystal panel, the second liquid crystal panel, and the backlight are compared with each other, patterns of the sections controlled by the plurality of video processing units are different from each other.

### CROSS-REFERENCE TO RELATED APPLICATION

The present application claims priority from Provisional Application No. 63/213,639, the content to which is hereby incorporated by reference into this application.

### BACKGROUND

### 1. Field

The disclosure relates to a video processer and a display device.

### 2. Description of the Related Art

JP 2015-191053 A discloses an example of a liquid crystal display device configured to perform video display using a plurality of liquid crystal panels. The liquid crystal display device disclosed in JP 2015-191053 A includes a light source unit, a first liquid crystal panel in which a first video is displayed based on a video signal, and a second liquid crystal panel which is disposed between the light source unit and the first liquid crystal panel, and in which a second video corresponding to the first video is displayed.

### SUMMARY

A display device configured to display a video by using a display panel including a plurality of liquid crystal panels and a light source unit (backlight) is desired to have an appropriate substrate structure in accordance with drive control of each of the plurality of liquid crystal panels and the backlight.

An object of the disclosure is to provide a video processer and a display device in which a substrate for controlling each of a plurality of liquid crystal panels and a backlight constituting a display panel may be appropriately arranged.

In order to solve the above issues, a video processer according to an aspect of the disclosure is a video processer configured to control a display panel including a first liquid crystal panel, a second liquid crystal panel, and a backlight disposed facing one another, and includes a plurality of video processing units configured to control the first liquid crystal panel, the second liquid crystal panel, and the backlight. The plurality of video processing units control at least the first liquid crystal panel among the first liquid crystal panel, the second liquid crystal panel, and the backlight, by dividing the first liquid crystal panel into a plurality of sections. In a case where at least two units of the first liquid crystal panel, the second liquid crystal panel, and the backlight are compared with each other, patterns of the sections controlled by the plurality of video processing units are different from each other.

A display device according to an aspect of the disclosure is provided with a display panel including a backlight having a plurality of light-emitting regions, a second liquid crystal panel superimposed on the backlight, and a first liquid crystal panel superimposed on the second liquid crystal panel, and a video processer. Further, the above-mentioned video processer is a video processer configured to control a display panel including a first liquid crystal panel, a second liquid crystal panel, and a backlight disposed facing one another, and includes a plurality of video processing units configured to control the first liquid crystal panel, the second liquid crystal panel, and the backlight. The plurality of video processing units control at least the first liquid crystal panel among the first liquid crystal panel, the second liquid crystal panel, and the backlight, by dividing the first liquid crystal panel into a plurality of sections. In a case where at least two units of the first liquid crystal panel, the second liquid crystal panel, and the backlight are compared with each other, patterns of the sections controlled by the plurality of video processing units are different from each other.

### BRIEF DESCRIPTION OF DRAWINGS

FIG. 1 is a block diagram illustrating a configuration of main portions of a display device according to a first embodiment.

FIG. 2 is a block diagram illustrating a configuration of main portions of a video processer included in a display device according to the first embodiment.

FIG. 3 is a flowchart illustrating an example of a video process in a display device according to the first embodiment.

FIG. 4 is a block diagram illustrating a configuration of main portions of a display device according to a first modified example of the first embodiment.

FIG. 5 is a block diagram illustrating a configuration of main portions of a video processer included in a display device according to the first modified example of the first embodiment.

FIG. 6 is a block diagram illustrating a configuration of main portions of a display device according to the first modified example of the first embodiment.

FIG. 7 is a block diagram illustrating a configuration of main portions of a display device according to a second modified example of the first embodiment.

FIG. 8 is a block diagram illustrating a configuration of main portions of a display device according to a third modified example of the first embodiment.

FIG. 9 is a block diagram illustrating a configuration of main portions of a display device according to a fourth modified example of the first embodiment.

FIG. 10 is a diagram illustrating an example of substrate arrangement on a rear face of a display device according to a comparative example.

FIG. 11 is a diagram illustrating an example of substrate arrangement on a rear face of a display device according to the first embodiment.

FIG. 12 is a diagram illustrating an example of substrate arrangement on a rear face of a display device according to a modified example of the first embodiment.

FIG. 13 is a diagram illustrating an example of substrate arrangement on a rear face of a display device according to a modified example of the first embodiment.

FIG. 14 is a block diagram illustrating a configuration of main portions of a display device according to a second embodiment.

FIG. 15 is a block diagram illustrating a configuration of main portions of a video processer included in a display device according to the second embodiment.

FIG. 16 is a block diagram illustrating a configuration of main portions of a video processer included in a display device according to the second embodiment.

FIG. 17 is a block diagram illustrating a configuration of main portions of a display device according to a first modified example of the second embodiment.

FIG. 18 is a block diagram illustrating a configuration of main portions of a video processer included in a display device according to the first modified example of the second embodiment.

FIG. 19 is a block diagram illustrating a configuration of main portions of a display device according to the first modified example of the second embodiment.

FIG. 20 is a block diagram illustrating a configuration of main portions of a display device according to a second modified example of the second embodiment.

FIG. 21 is a block diagram illustrating a configuration of main portions of a display device according to a third modified example of the second embodiment.

FIG. 22 is a block diagram illustrating a configuration of main portions of a video processer included in a display device according to the third modified example of the second embodiment.

FIG. 23 is a block diagram illustrating a configuration of main portions of a display device according to the third modified example of the second embodiment.

FIG. 24 is a block diagram illustrating a configuration of main portions of a display device according to a fourth modified example of the second embodiment.

FIG. 25 is a block diagram illustrating a configuration of main portions of a video processer included in a display device according to the fourth modified example of the second embodiment.

### DETAILED DESCRIPTION

### First Embodiment

Hereinafter, a display device 1 according to a first embodiment of the disclosure will be described in detail. The display device 1 according to the first embodiment divides a liquid crystal panel 21 into a plurality of sections and individually controls each section in the liquid crystal panel 21. That is, the display device 1 divides a display region of the liquid crystal panel 21 into the plurality of sections, and processes a video signal for each section individually, thereby making it possible to display a video in a display panel 20. Thus, even when the amount of data of the input video signal is large, the display device 1 may appropriately display the video in the display panel 20 by dividing the video signal to process.

Specifically, the display device 1 is configured to allow one 8K4K video (a video having a resolution of 8K4K) to be represented by four 4K2K videos being arranged and displayed in the display region of the liquid crystal panel 21.

“8K4K” refers to a resolution of “7680 horizontal pixels by 4320 vertical pixels”. “8K4K” is also referred to simply as “8K”. “4K2K” refers to a resolution of “3840 horizontal pixels by 2160 vertical pixels”. One 8K4K video may be represented as a video made of four videos (two in the horizontal direction, two in the vertical direction) 4K2K videos (each having a resolution of 4K2K). That is, one 8K4K video may be represented by combining four 4K2K videos. “4K2K” is also referred to simply as “4K”.

Alternatively, the display device 1 may be configured to allow one 8K4K video to be represented by two 4K4K videos being arranged and displayed in the display region of the liquid crystal panel 21. “4K4K” refers to a resolution of “3840 horizontal pixels by 4320 vertical pixels”. By arranging two 4K4K videos in the horizontal direction, one 8K4K video may be configured.

In the following description, the display device 1 is configured to divide a video into four sections (divided video sections) of A, B, C, and D in the liquid crystal panel 21. Specifically, the display region of the liquid crystal panel 21 is divided into two sections longitudinally and two sections laterally. The upper-left section of the display region is defined as a divided video section A, the upper-right section of the display region is defined as a divided video section B, the lower-left section of the display region is defined as a divided video section C, and the lower-right section of the display region is defined as a divided video section D. The display region of the liquid crystal panel 21 has a resolution of 8K as a whole, and each of the divided video sections A to D has a resolution of 4K.

### Display Device

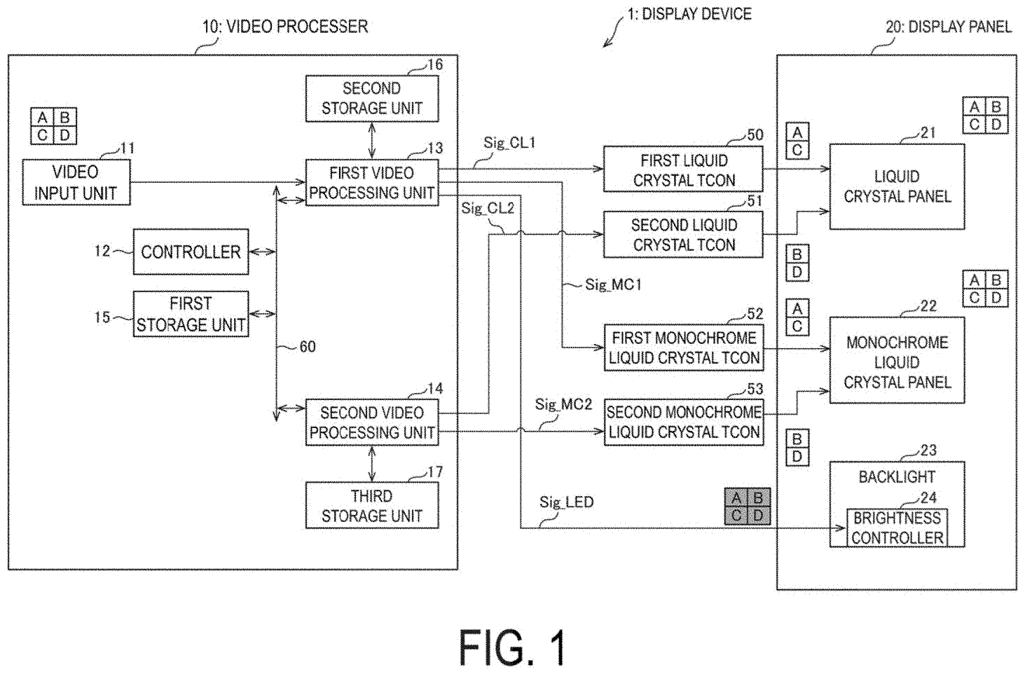

FIG. 1 is a block diagram illustrating a configuration of main portions of the display device 1 according to the first embodiment. As illustrated in FIG. 1, the display device 1 includes a video processer 10, the display panel 20, a first liquid crystal timing controller (TCON) 50, a second liquid crystal TCON 51, a first monochrome liquid crystal TCON 52, and a second monochrome liquid crystal TCON 53.

The display panel 20 includes the liquid crystal panel 21 (first liquid crystal panel), a monochrome liquid crystal panel 22 (second liquid crystal panel), and a backlight 23. That is, the display panel 20 has a configuration in which the monochrome liquid crystal panel 22 is superimposed on the backlight 23 formed of a plurality of light-emitting regions, and the liquid crystal panel 21 is superimposed on the monochrome liquid crystal panel 22. More specifically, when the side of the display panel 20 on which a video is displayed is referred to as a front face, and the opposite side thereof is referred to as a back face, the backlight 23 is disposed on the back face side of the display panel 20. The monochrome liquid crystal panel 22 and the liquid crystal panel 21 are disposed in that order to be superimposed on the front face side of the backlight 23. The display panel 20 may display the video by controlling the transmittance at which light emitted from the backlight 23 passes through the pixels, in each of the liquid crystal panel 21 and the monochrome liquid crystal panel 22.

The liquid crystal panel 21 and the monochrome liquid crystal panel 22 each form one liquid crystal display panel. In the present embodiment, a device including the liquid crystal panel 21, the monochrome liquid crystal panel 22, and the backlight 23 is referred to as the display panel 20.

In the display panel 20, the backlight 23 is divided into the plurality of light-emitting regions, and each light-emitting region is provided with a plurality of light-emitting units (not illustrated) configured to emit light onto the monochrome liquid crystal panel 22 and the liquid crystal panel 21. The backlight 23 includes, for example, light emitting diodes (LEDs) as the light-emitting units.

The liquid crystal panel 21 is a liquid crystal panel configured to display an 8K4K video based on a color video signal. For example, the liquid crystal panel 21 is a liquid crystal panel including three subpixels of R, G, and B in each pixel. On the other hand, the monochrome liquid crystal panel 22 is a full HD liquid crystal panel. The monochrome liquid crystal panel 22 is configured to display a black-and-white video signal at each pixel. Because of this, the monochrome liquid crystal panel 22 may adjust brightness at each pixel. The backlight 23 is divided into, for example, 32×16 areas, and brightness may be controlled for each area. The display panel 20 is configured to separately control the LEDs provided in each of the plurality of light-emitting regions in the backlight 23, and to control the drive of each of the liquid crystal panel 21 and the monochrome liquid crystal panel 22 in conjunction with the control of the LEDs. This configuration makes it possible for the display panel 20 to improve the contrast of the video to be displayed.

The video processer 10 performs various signal processing to display a video in the display panel 20 based on the video signal that is input as a color video signal.

The video processer 10 has a configuration including a video input unit 11, a controller 12 (CPU), a first video processing unit 13, a second video processing unit 14, a first storage unit 15, a second storage unit 16, and a third storage unit 17. The controller 12, the first storage unit 15, the second storage unit 16, and the third storage unit 17 may be provided separately from the video processer 10.

The video input unit 11 transmits the input video signal to the first video processing unit 13. The first video processing unit 13 receives, from the video input unit 11, both the video signal of the video to be displayed on the divided video sections A and C and the video signal of the video to be displayed on the divided video sections B and D in the liquid crystal panel 21. The first video processing unit 13 transmits the video signal to be displayed on the divided video sections B and D to the second video processing unit 14 through a bus 60 via the controller 12.

This allows the first video processing unit 13 to process the video to be displayed on the divided video sections A and C in the liquid crystal panel 21, and allows the second video processing unit 14 to process the video to be displayed on the divided video sections B and D in the liquid crystal panel 21.

The above-discussed configuration is such that, in the first video processing unit 13, the input video signal is divided into the video signal of the video to be displayed on the divided video sections A and C (hereinafter, referred to as a left half video in some case) and the video signal of the video to be displayed on the divided video sections B and D (hereinafter, referred to as a right half video in some case), and the video signal of the right half video is transmitted to the second video processing unit 14.

However, the video input unit 11 includes a video dividing unit (not illustrated) configured to divide the input video signal into the video signal of the right half video and the video signal of the left half video. Then, the video input unit 11 may be configured to transmit the video signals of the process-target videos to the first video processing unit 13 and the second video processing unit 14, respectively. In other words, the video input unit 11 may be configured to transmit the video signal of the left half video to the first video processing unit 13, and transmit the video signal of the right half video to the second video processing unit 14.

Further, the video input unit 11 may be configured to transmit all the input video signals to each of the first video processing unit 13 and the second video processing unit 14. In the case of this configuration, each of the first video processing unit 13 and the second video processing unit 14 may be configured to discard the video signal not to be processed among the received video signals.

The first video processing unit 13 and the second video processing unit 14 each perform signal processing based on the video signal of the video to be displayed on the divided video sections assigned to each thereof.

In the first embodiment, the first video processing unit 13 performs signal processing on the video signal of the video to be displayed on the divided video sections A and C. The second video processing unit 14 performs signal processing on the video signal of the video to be displayed on the divided video sections B and D.

The first video processing unit 13 generates an RGB liquid crystal control signal Sig_CL1 including a display control signal for controlling the divided video sections A and C in the liquid crystal panel 21. Further, the first video processing unit 13 generates a monochrome liquid crystal control signal Sig_MC1 including a display control signal for controlling the sections corresponding to divided video sections A and C in the monochrome liquid crystal panel 22. The sections corresponding to the divided video sections A and C in the monochrome liquid crystal panel 22 are sections overlapping with the divided video sections A and C, that is, are sections having the same section pattern as the divided video sections A and C in the monochrome liquid crystal panel 22 in a plan view of the display panel 20.

The first video processing unit 13 may control the divided video sections A and C in the liquid crystal panel 21 by transmitting the RGB liquid crystal control signal Sig_CL1 to the liquid crystal panel 21 via the first liquid crystal TCON 50. Further, the first video processing unit 13 may control the sections corresponding to the divided video sections A and C in the monochrome liquid crystal panel 22 by transmitting the monochrome liquid crystal control signal Sig_MC1 to the monochrome liquid crystal panel 22 via the first monochrome liquid crystal TCON 52.

The second video processing unit 14 generates an RGB liquid crystal control signal Sig_CL2 including a display control signal for controlling the divided video sections B and D in the liquid crystal panel 21. Further, the second video processing unit 14 generates a monochrome liquid crystal control signal Sig_MC2 including a display control signal for controlling the sections corresponding to divided video sections B and D in the monochrome liquid crystal panel 22. The sections corresponding to the divided video sections B and D in the monochrome liquid crystal panel 22 are sections overlapping with the divided video sections B and D, that is, are sections having the same section pattern as the divided video sections B and D in the monochrome liquid crystal panel 22 in the plan view of the display panel 20.

The second video processing unit 14 may control the divided video sections B and D in the liquid crystal panel 21 by transmitting the RGB liquid crystal control signal Sig_CL2 to the liquid crystal panel 21 via the second liquid crystal TCON 51. Further, the second video processing unit 14 may control the sections corresponding to the divided video sections B and D in the monochrome liquid crystal panel 22 by transmitting the monochrome liquid crystal control signal Sig_MC2 to the monochrome liquid crystal panel 22 via the second monochrome liquid crystal TCON 53.

The RGB liquid crystal control signal Sig_CL1 and the RGB liquid crystal control signal Sig_CL2 are color video signals including display control data indicating a gray scale value of each of R, G, and B. On the other hand, the monochrome liquid crystal control signal Sig_MC1 and the monochrome liquid crystal control signal Sig_MC2 are black-and-white video signals including display control signals indicating a gray scale value as a gray scale.

Furthermore, the first video processing unit 13 and the second video processing unit 14 each generate LED control data for controlling the divided sections in the backlight 23 respectively corresponding to the divided video sections to be processed by the first and second video processing units. The divided sections in the backlight 23 respectively corresponding to the divided video sections are sections having the same section pattern as the divided video sections in the backlight 23 in a plan view of the display panel 20.

The first video processing unit 13 and the second video processing unit 14 transmit and/or receive the generated LED control data between each other via the controller 12 through the bus 60. The first video processing unit 13 transmits, to the backlight 23, an LED control signal Sig_LED including the LED control data received from the second video processing unit 14 and the LED control data generated by the first video processing unit 13 itself. In this way, the first video processing unit 13 may control all the sections in the backlight 23 by transmitting the LED control signal Sig_LED to the backlight 23. That is, in the backlight 23, the pattern of the sections controlled by the first video processing unit 13 may be made to be the whole backlight 23.

The detailed configuration of the first video processing unit 13 and the second video processing unit 14 will be described later.

The controller 12 is, for example, an arithmetic processing unit, such as a CPU, configured to comprehensively control various operations of constituent elements included in the video processer 10. In the present embodiment, the controller 12 is connected to each of the first video processing unit 13 and the second video processing unit 14 via the bus 60.

The first storage unit 15 stores data to be used in the control processing by the controller 12. The second storage unit 16 stores data to be used in the control processing by the first video processing unit 13. The second storage unit 16 may also store the LED control data generated by the first video processing unit 13. The third storage unit 17 stores data to be used in the control processing by the second video processing unit 14. The third storage unit 17 may also store the LED control data generated by the second video processing unit 14.

The first liquid crystal TCON 50 receives the RGB liquid crystal control signal Sig_CL1 transmitted from the first video processing unit 13, and transmits a signal necessary to control the liquid crystal panel 21 to the liquid crystal panel 21. Likewise, the second liquid crystal TCON 51 receives the RGB liquid crystal control signal Sig_CL2 transmitted from the second video processing unit 14, and transmits a signal necessary to control the liquid crystal panel 21 to the liquid crystal panel 21.

The first monochrome liquid crystal TCON 52 receives the monochrome liquid crystal control signal Sig_MC1 transmitted from the first video processing unit 13, and transmits a signal necessary to control the monochrome liquid crystal panel 22 to the monochrome liquid crystal panel 22. Likewise, the second monochrome liquid crystal TCON 53 receives the monochrome liquid crystal control signal Sig_MC2 transmitted from the second video processing unit 14, and transmits a signal necessary to control the monochrome liquid crystal panel 22 to the monochrome liquid crystal panel 22.

The liquid crystal panel 21 drives a source driver and a gate driver (not illustrated) to display a color video based on the signals transmitted from the first liquid crystal TCON 50 and the second liquid crystal TCON 51. The monochrome liquid crystal panel 22 drives a source driver and a gate driver (not illustrated) to display a black-and-white video based on the signals transmitted from the first monochrome liquid crystal TCON 52 and the second monochrome liquid crystal TCON 53.

The backlight 23 is divided into the plurality of sections, and each section is provided with a plurality of light-emitting units (not illustrated) configured to emit light onto the monochrome liquid crystal panel 22 and the liquid crystal panel 21. The backlight 23 includes, for example, light emitting diodes (LEDs) as the light-emitting units. The display panel 20 may display the video by controlling the transmittance at which the light emitted from the backlight 23 passes through the pixels in the liquid crystal panel 21 and the monochrome liquid crystal panel 22.

Further, the backlight 23 includes a brightness controller 24 configured to control the light emission of each of the plurality of LEDs. The brightness controller 24 controls the amount of light emitted from each of the plurality of LEDs based on the LED control signal Sig_LED received from the first video processing unit 13.

Hereinafter, ranges in the backlight 23 respectively corresponding to the divided video sections A to D are referred to as divided sections A to D in some case.

### First Video Processing Unit and Second Video Processing Unit

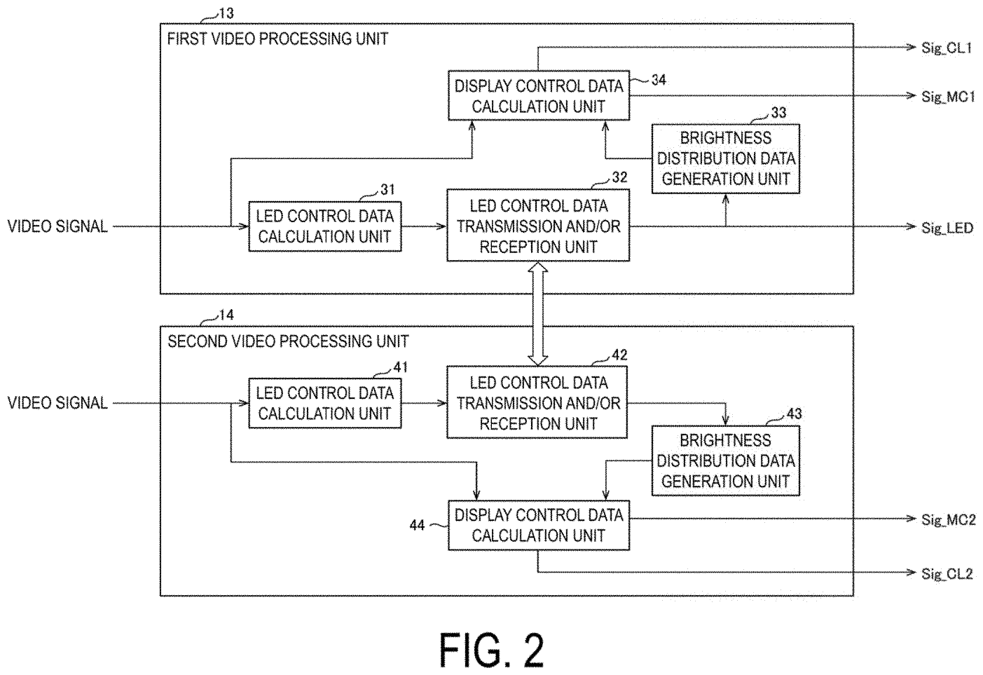

The configuration of the first video processing unit 13 and the second video processing unit 14 will be described below with reference to FIG. 2. FIG. 2 is a block diagram illustrating a configuration of main portions of the video processer 10 included in the display device 1 according to the first embodiment. In FIG. 2, in particular, the configuration of main portions of the first video processing unit 13 and second video processing unit 14 in the video processer 10 is illustrated.

The first video processing unit 13 includes an LED control data calculation unit 31, an LED control data transmission and/or reception unit 32, a brightness distribution data generation unit 33, and a display control data calculation unit 34. Similarly, the second video processing unit 14 includes an LED control data calculation unit 41, an LED control data transmission and/or reception unit 42, a brightness distribution data generation unit 43, and a display control data calculation unit 44.

The LED control data calculation unit 31 generates LED control data for controlling the light emission of the LEDs included in the divided sections A and C in the backlight 23 based on the video signal of the video to be displayed in the divided video sections A and C. Similarly, the LED control data calculation unit 41 generates LED control data for controlling the light emission of the LEDs included in the divided sections B and D in the backlight 23 based on the video signal of the video to be displayed in the divided video sections B and D.

For example, each of the LED control data calculation unit 31 and the LED control data calculation unit 41 may generate the LED control data as follows.

The video to be displayed in the liquid crystal panel 21 is an 8K4K video, while the video to be displayed in the divided video sections A and C, and the video to be displayed in the divided video sections B and D are each a 4K4K video. Thus, the number of pixels of the video displayed in the divided video sections A and C, and the number of pixels of the video displayed in the divided video sections B and D are each 3840 horizontal pixels by 4320 vertical pixels.

The LED control data calculation unit 31 and the LED control data calculation unit 41 each perform sub-sampling processing on the video signal including information related to the brightness of 3840×4320 pixels. With this, each of the LED control data calculation unit 31 and the LED control data calculation unit 41 obtains a reduced-size video including brightness of 160×160 pixels. The reduced-size video is assumed to be a video divided into 16×16 areas (each area size is 10×10 pixels). By determining the maximum value and the mean value of the brightness of the pixels for each area, maximum-values data including 16×16 maximum values and mean-values data including 16-16 mean values are obtained. Then, the LED control data calculation unit 31 and the LED control data calculation unit 41 may each calculate the LED control data representing the LED brightness of 16×16 areas, based on any of the obtained maximum-values data, the obtained mean-values data, and the weighted mean of the maximum-values data and the mean-values data.

The LED control data transmission and/or reception unit 32 and the LED control data transmission and/or reception unit 42 transmit and/or receive, between each other, the LED control data generated by each of the LED control data calculation unit 31 and the LED control data calculation unit 41.

This makes it possible for the first video processing unit 13 and the second video processing unit 14 to acquire the LED control data for controlling the whole backlight 23. Specifically, as illustrated in FIGS. 1 and 2, the LED control data transmission and/or reception unit 32 and the LED control data transmission and/or reception unit 42 transmit and/or receive the LED control data between each other via the controller 12. The first video processing unit 13 stores the LED control data generated by the first video processing unit 13 itself and the LED control data received from the second video processing unit 14 in the second storage unit 16. The second video processing unit 14 stores the LED control data generated by the second video processing unit 14 itself and the LED control data received from the first video processing unit 13 in the third storage unit 17.

Then, as illustrated in FIG. 2, the LED control data transmission and/or reception unit 32 included in the first video processing unit 13 transmits an LED control signal Sig_LED including the LED control data for controlling the whole backlight 23 (the divided sections A, B, C, and D) to the brightness controller 24. In this manner, the video processer 10 may control the light emission of the LEDs provided throughout the backlight 23 by the first video processing unit 13 transmitting the LED control signal Sig_LED to the brightness controller 24.

The video processer 10 has a configuration in which the first video processing unit 13 transmits the LED control signal Sig_LED to the brightness controller 24, but the second video processing unit 14 may transmit the LED control signal Sig_LED to the brightness controller 24 instead of the first video processing unit 13.

The brightness distribution data generation unit 33 generates brightness distribution data, which is brightness distribution of light emitted from the LEDs provided in the divided sections A and C, based on the LED control data for controlling the light emission of the LEDs provided throughout the backlight 23. At this time, the brightness distribution data generation unit 33 generates the brightness distribution data with reference to (1) the LED control data for controlling the LEDs provided in the divided sections A and C, and (2) the LED control data for controlling the LEDs provided in the sections other than the divided sections A and C; the LEDs provided in the sections other than the divided sections A and C affect the brightness of the light emitted from the LEDs provided in the divided sections A and C.

The LED control data satisfying the condition of (2) may be the control data of the LEDs provided corresponding to the position of a pixel column included in the divided video sections B and D, which is arranged along a boundary between the divided video sections A and C and the divided video sections B and D. Alternatively, the LED control data that satisfies the condition of (2) may be control data of all the LEDs provided in the divided sections B and D.

Thus, the brightness distribution data generation unit 33 may generate the brightness distribution data of the LEDs provided in the divided sections A and C of the backlight 23 in consideration of the effect of the light emitted from the LEDs provided in the divided sections B and D of the backlight 23. The brightness distribution data generation unit 33 transmits the generated brightness distribution data to the display control data calculation unit 34.

Similarly, the brightness distribution data generation unit 43 generates brightness distribution data, which is brightness distribution of light emitted from the LEDs provided in the divided sections B and D, based on the LED control data for controlling the light emission of the LEDs provided throughout the backlight 23. At this time, the brightness distribution data generation unit 43 generates the brightness distribution data with reference to (3) the LED control data for controlling the LEDs provided in the divided sections B and D, and (4) the LED control data for controlling the LEDs provided in the sections other than the divided sections B and D; the LEDs provided in the sections other than the divided sections B and D affect the brightness of the light emitted from the LEDs provided in the divided sections B and D.

The LED control data satisfying the condition of (4) may be the control data of the LEDs provided corresponding to the position of a pixel column included in the divided video sections A and C, which is arranged along a boundary between the divided video sections B and D and the divided video sections A and C. Alternatively, the LED control data that satisfies the condition of (4) may be control data of all the LEDs provided in the divided sections A and C.

Thus, the brightness distribution data generation unit 43 may generate the brightness distribution data of the LEDs provided in the divided sections B and D of the backlight 23 in consideration of the effect of the light emitted from the LEDs provided in the divided sections A and C of the backlight 23. The brightness distribution data generation unit 43 transmits the generated brightness distribution data to the display control data calculation unit 44.

The display control data calculation unit 34 calculates monochrome display control data for controlling the sections corresponding to the divided video sections A and C in the monochrome liquid crystal panel 22, with reference to the brightness distribution data received from the brightness distribution data generation unit 33. Then, the display control data calculation unit 34 transmits the monochrome liquid crystal control signal Sig_MC1 including the calculated monochrome display control data to the first monochrome liquid crystal TCON 52.

Further, the display control data calculation unit 34 calculates RGB display control data for controlling the divided video sections A and C in the liquid crystal panel 21, with reference to the brightness distribution data. Then, the display control data calculation unit 34 transmits the RGB liquid crystal control signal Sig_CL1 including the calculated RGB display control data to the first liquid crystal TCON 50.

Similarly, the display control data calculation unit 44 calculates monochrome display control data for controlling the sections corresponding to the divided video section B and D in the monochrome liquid crystal panel 22, with reference to the brightness distribution data received from the brightness distribution data generation unit 43. Then, the display control data calculation unit 44 transmits the monochrome liquid crystal control signal Sig_MC2 including the calculated monochrome display control data to the second monochrome liquid crystal TCON 53.

Further, the display control data calculation unit 44 calculates RGB display control data for controlling the divided video sections B and D in the liquid crystal panel 21, with reference to the brightness distribution data. Then, the display control data calculation unit 44 transmits the RGB liquid crystal control signal Sig_CL2 including the calculated RGB display control data to the second liquid crystal TCON 51.

### Video Processing Method

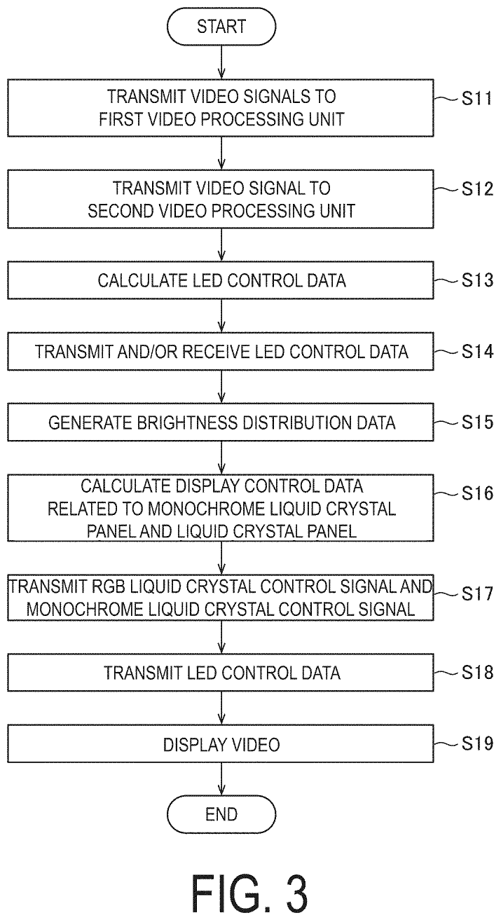

Next, a video processing method in the display device 1 according to the first embodiment of the disclosure will be described with reference to FIG. 3. FIG. 3 is a flowchart illustrating an example of a video process in the display device 1 according to the first embodiment.

First, in the video processer 10, the video input unit 11 transmits video signals for the divided video sections A to D to the first video processing unit 13 (step S11). Next, the first video processing unit 13 transmits the video signal for the divided video sections B and D among the received video signals for the divided video sections A to D, to the second video processing unit 14 (step S12).

Subsequently, each of the first video processing unit 13 and the second video processing unit 14 calculates the LED control data for controlling the divided sections of the backlight 23 corresponding to the divided video sections to be processed by the corresponding video processing unit (step S13). Specifically, in the first video processing unit 13, the LED control data calculation unit 31 calculates the LED control data of the divided sections A and C in the backlight 23. At the same time, in the second video processing unit 14, the LED control data calculation unit 41 calculates the LED control data of the divided sections B and D in the backlight 23. The LED control data transmission and/or reception unit 32 and the LED control data transmission and/or reception unit 42 transmit and/or receive, between each other, the LED control data calculated by each of the LED control data calculation unit 31 and the LED control data calculation unit 41 (step S14).

Next, each of the brightness distribution data generation unit 33 and the brightness distribution data generation unit 43 generates the brightness distribution data for the divided sections of the backlight 23 (step S15). In other words, the brightness distribution data generation unit 33 generates the brightness distribution data of the divided sections A and C based on the LED control data of the divided sections A and C in the backlight 23 and at least part of the LED control data of the divided sections B and D in the backlight 23.

The brightness distribution data generation unit 43 generates the brightness distribution data of the divided sections B and D based on the LED control data of the divided sections B and D in the backlight 23 and at least part of the LED control data of the divided sections A and C in the backlight 23.

Subsequently, the display control data calculation unit 34 and the display control data calculation unit 44 each calculate display control data related to the monochrome liquid crystal panel 22 and the liquid crystal panel 21 (step S16). In other words, the display control data calculation unit 34 calculates monochrome display control data for controlling the sections corresponding to the divided video sections A and C in the monochrome liquid crystal panel 22, with reference to the brightness distribution data generated in the brightness distribution data generation unit 33. Further, the display control data calculation unit 34 calculates RGB display control data for controlling the divided video sections A and C in the liquid crystal panel 21, with reference to the brightness distribution data.

The display control data calculation unit 44 calculates monochrome display control data for controlling the sections corresponding to the divided video section B and D in the monochrome liquid crystal panel 22, with reference to the brightness distribution data generated in the brightness distribution data generation unit 43. Further, the display control data calculation unit 34 calculates RGB display control data for controlling the divided video sections B and D in the liquid crystal panel 21, with reference to the brightness distribution data.

Thereafter, the display control data calculation unit 34 and the display control data calculation unit 44 each transmit an RGB liquid crystal control signal including the calculated RGB display control data, and a monochrome liquid crystal control signal including the calculated monochrome display control data (step S17).

In other words, the display control data calculation unit 34 transmits the RGB liquid crystal control signal Sig_CL1 to the first liquid crystal TCON 50, and transmits the monochrome liquid crystal control signal Sig_MC1 to the first monochrome liquid crystal TCON 52. The display control data calculation unit 44 transmits the RGB liquid crystal control signal Sig_CL2 to the second liquid crystal TCON 51, and transmits the monochrome liquid crystal control signal Sig_MC2 to the second monochrome liquid crystal TCON 53.

Subsequently, the LED control data transmission and/or reception unit 32 transmits, to the brightness controller 24, the LED control signal Sig_LED including the LED control data for controlling all the divided sections in the backlight 23 (step S18). In this manner, by the first video processing unit 13 transmitting the LED control signal Sig_LED to the brightness controller 24, it is possible to control the light emission of the LEDs provided in all the divided sections in the backlight 23.

The video is displayed in the display panel 20 (step S19) based on the RGB liquid crystal control signals Sig_CL1 and Sig_CL2, and the monochrome liquid crystal control signals Sig_MC1 and Sig_MC2, which are transmitted from the first video processing unit 13 and the second video processing unit 14 in step S17, and based on the LED control signal Sig_LED transmitted from the first video processing unit 13 in step S18.

The execution order of step S17 and step S18 discussed above is not limited to that order; step S17 may be executed after step S18, or step S17 and step S18 may be executed at the same time.

As described above, the display device 1 according to the first embodiment has a configuration in which the light emission of the LEDs provided in all the divided sections in the backlight 23 is controlled by transmitting the LED control signal Sig_LED related to all the divided sections from the video processer 10.

Meanwhile, in the display device 1 according to the first embodiment, the RGB liquid crystal control signal Sig_CL1 for controlling the divided video sections A and C, and the RGB liquid crystal control signal Sig_CL2 for controlling the divided video sections B and D are separately transmitted from the video processer 10 to the liquid crystal panel 21. With the above configuration, the display device 1 according to the first embodiment is configured to individually perform control of the divided video sections A and C, and control of the divided video sections B and D in the liquid crystal panel 21.

Further, in the display device 1 according to the first embodiment, the monochrome liquid crystal control signal Sig_MC1 corresponding to the divided video sections A and C, and the monochrome liquid crystal control signal Sig_MC2 corresponding to the divided video sections B and D are separately transmitted from the video processer 10 to the monochrome liquid crystal panel 22. With the above configuration, the display device 1 according to the first embodiment is configured to individually perform gray scale control of the sections corresponding to the divided video sections A and C, and gray scale control of the sections corresponding to the divided video sections B and D in the monochrome liquid crystal panel 22. That is, in the display device 1 according to the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

Note that in the video processer 10, the first video processing unit 13 transmits the monochrome liquid crystal control signal Sig_MC1 for controlling the sections corresponding to the divided video sections A and C in the monochrome liquid crystal panel 22, to the monochrome liquid crystal panel 22. Further, the second video processing unit 14 is configured to transmit, to the monochrome liquid crystal panel 22, the monochrome liquid crystal control signal Sig_MC2 for controlling the sections corresponding to divided video sections B and D in the monochrome liquid crystal panel 22. Accordingly, the monochrome liquid crystal control signal Sig_MC1 includes only the control information of the sections corresponding to the divided video sections A and C, and the monochrome liquid crystal control signal Sig_MC2 includes only the control information of the sections corresponding to the divided video sections B and D.

Because the distribution range of the brightness of the light emitted from the LEDs expands, the brightness of the divided sections A and C, particularly, the brightness of the divided sections A and C near the boundary with the divided sections B and D is affected by the light emitted from the LEDs provided in the divided sections B and D. Conversely, the brightness of the divided sections B and D, particularly, the brightness of the divided sections B and D near the boundary with the divided sections A and C is affected by the light emitted from the LEDs provided in the divided sections A and C. Accordingly, in order for the brightness distribution data generation unit 33 to generate the brightness distribution data of the divided sections A and C of the backlight 23 (the processing in step S15), it is preferable that the first video processing unit 13 be configured in such a manner as to also refer to the LED control data for controlling the LEDs provided in the divided sections B and D. Further, in order for the brightness distribution data generation unit 43 to generate the brightness distribution data of the divided sections B and D of the backlight 23, it is preferable that the second video processing unit 14 be configured in such a manner as to also refer to the LED control data for controlling the LEDs provided in the divided sections A and C.

Meanwhile, the distribution range of the brightness of light passing through a certain pixel of the monochrome liquid crystal panel 22 and striking the liquid crystal panel 21 is narrow when the monochrome liquid crystal panel 22 and the liquid crystal panel 21 are in close contact with each other. Because of this, the sections corresponding to the divided video sections A and C are hardly affected by the sections corresponding to the divided video sections B and D in terms of brightness in the monochrome liquid crystal panel 22. Conversely, the sections corresponding to the divided video sections B and D are hardly affected by the sections corresponding to the divided video sections A and C in terms of brightness in the monochrome liquid crystal panel 22. Because of this, the display control data calculation unit 34 does not necessarily need control information for controlling the sections corresponding to the divided video sections B and D at the time of generating the display control data of the sections corresponding to the divided video sections A and C in the monochrome liquid crystal panel 22 (the processing in step S16). Likewise, the display control data calculation unit 44 does not necessarily need control information for controlling the sections corresponding to the divided video sections A and C at the time of generating the display control data of the sections corresponding to the divided video sections B and D in the monochrome liquid crystal panel 22.

However, the display panel 20 may have a configuration in which a sheet having light diffusion properties is provided between the liquid crystal panel 21 and the monochrome liquid crystal panel 22. In the case of such a configuration, because the distribution range of the brightness of the light that passes through a certain pixel of the monochrome liquid crystal panel 22 and strikes the liquid crystal panel 21 expands, it is preferable that the display control data calculation unit 34 be configured in such a manner as to refer to the control information for controlling the sections corresponding to the divided video sections B and D at the time of generating the display control data of the sections corresponding to the divided video sections A and C in the monochrome liquid crystal panel 22. Likewise, it is preferable that the display control data calculation unit 44 be configured in such a manner as to refer to the control information for controlling the sections corresponding to the divided video sections A and C at the time of generating the display control data of the sections corresponding to the divided video sections B and D in the monochrome liquid crystal panel 22. For example, the following configuration may be adopted: the monochrome display control data of two pixel-columns that are respectively present in the sections corresponding to the divided video sections A and C and in the sections corresponding to the divided video sections B and D, and are arranged along the boundary between the sections corresponding to the divided video sections A and C and the sections corresponding to the divided video sections B and D, may be transmitted and/or received between the display control data calculation unit 34 and the display control data calculation unit 44.

In the display device 1 according to the first embodiment, the liquid crystal panel 21 is a liquid crystal panel configured to display color video signals. However, in a case where the video to be displayed in the display panel 20 is a black-and-white video, the liquid crystal panel 21 may be a liquid crystal panel configured to display a black-and-white video signal similar to the monochrome liquid crystal panel 22.

Further, in the display device 1 according to the first embodiment, the liquid crystal panel 21 is an 8K4K liquid crystal panel, and the monochrome liquid crystal panel 22 is a full HD liquid crystal panel. In other words, although the resolution of the monochrome liquid crystal panel 22 is lower than the resolution of the liquid crystal panel 21, the resolution of both the liquid crystal panels may be the same.

In the display device 1 according to the first embodiment, the liquid crystal panel 21 and the monochrome liquid crystal panel 22 are each configured to be controlled in such a manner as to display the video in the sections divided into two portions on the left and right sides (the divided video sections A and C, and the divided video sections B and D). However, they may be configured to be controlled in such a manner as to display the video in the sections divided into two portions on the upper and lower sides (divided video sections A and B, and divided video sections C and D).

As described above, in the display device 1 according to the first embodiment, even in the case where the display region of the liquid crystal panel 21 is divided into the plurality of sections, and the video signal for each of the sections is processed individually, the LED control signal Sig_LED may be transmitted through a single wiring line connecting the first video processing unit 13 and the brightness controller 24.

Thus, the brightness controller 24 may have a configuration similar to that of a case in which the video signal is processed without dividing the display region of the liquid crystal panel 21 into the plurality of sections. Accordingly, even in the case where the display region of the liquid crystal panel 21 is divided into the plurality of sections, and the video signal for each of the sections is processed individually, it is unnecessary to newly design the brightness controller 24. Thus, the display device 1 according to the first embodiment may suppress an increase in the manufacturing cost.

### First Modified Example

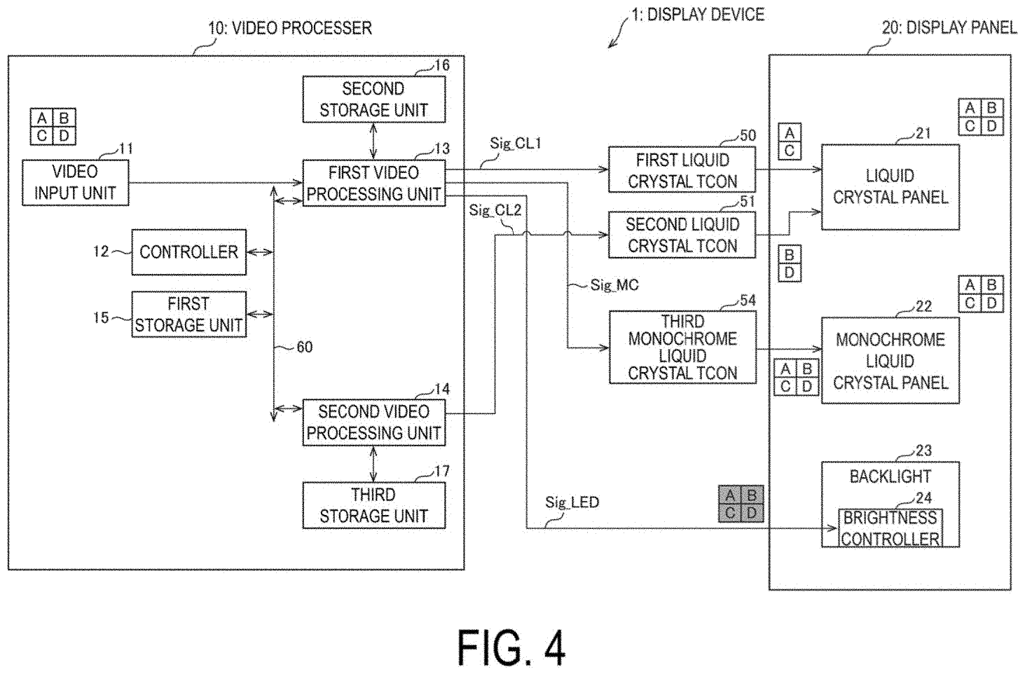

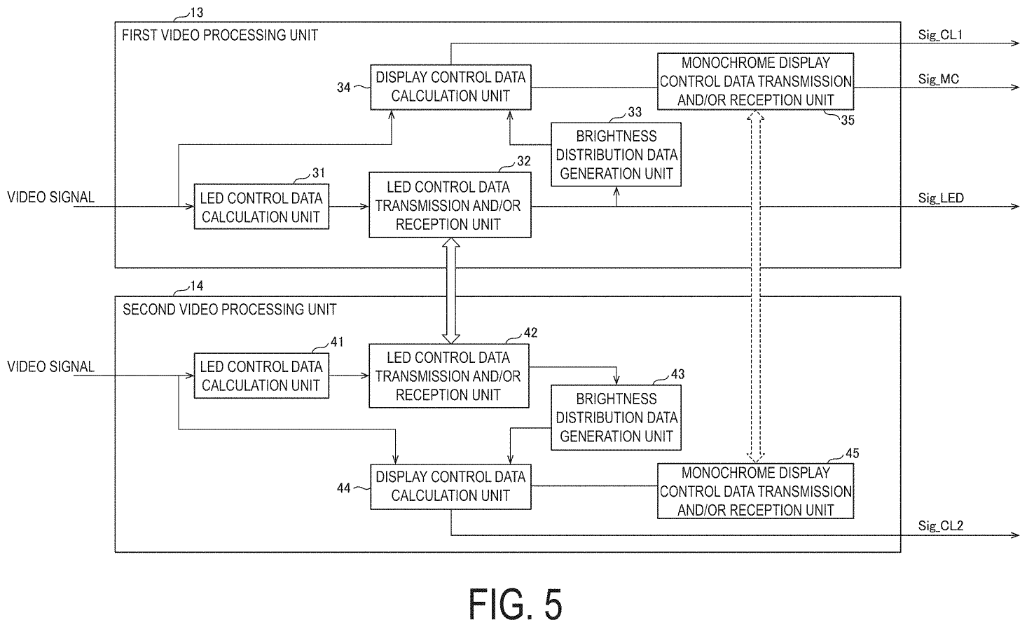

Next, a configuration of a display device 1 according to a first modified example of the first embodiment will be described with reference to FIGS. 4 and 5. FIG. 4 is a block diagram illustrating a configuration of main portions of the display device 1 according to the first modified example of the first embodiment. FIG. 5 is a block diagram illustrating a configuration of main portions of a video processer 10 included in the display device 1 according to the first modified example of the first embodiment.

As illustrated in FIG. 4, the display device 1 according to the first modified example of the first embodiment has a configuration including a third monochrome liquid crystal TCON 54 instead of the first monochrome liquid crystal TCON 52 and second monochrome liquid crystal TCON 53 in the configuration of the display device 1 according to the first embodiment. A monochrome liquid crystal control signal Sig_MC is transmitted from a first video processing unit 13 in the video processer 10 to the third monochrome liquid crystal TCON 54.

The video processer 10 is configured to transmit and/or receive display control data (monochrome display control data) to be transmitted to the monochrome liquid crystal panel 22, in addition to the LED control data, between the first video processing unit 13 and a second video processing unit 14.

That is, as illustrated in FIG. 5, in the display device 1 according to the first modified example of the first embodiment, the first video processing unit 13 further includes a monochrome display control data transmission and/or reception unit 35, and the second video processing unit 14 further includes a monochrome display control data transmission and/or reception unit 45.

As for other configurations, the display device 1 according to the first modified example of the first embodiment has the same configurations as those of the display device 1 according to the first embodiment. Because of this, the same constituent elements are denoted by the same reference signs and description thereof will be omitted.

As illustrated in FIG. 5, in the first video processing unit 13 according to the first modified example of the first embodiment, a display control data calculation unit 34 calculates monochrome display control data for controlling the sections corresponding to the divided video sections A and C in the monochrome liquid crystal panel 22 with reference to the brightness distribution data. The display control data calculation unit 34 transmits this monochrome display control data to the monochrome display control data transmission and/or reception unit 35.

In the second video processing unit 14 according to the first modified example of the first embodiment, a display control data calculation unit 44 calculates monochrome display control data for controlling the sections corresponding to the divided video section B and D in the monochrome liquid crystal panel 22 with reference to the brightness distribution data. The display control data calculation unit 44 transmits this monochrome display control data to the monochrome display control data transmission and/or reception unit 45.

The monochrome display control data transmission and/or reception unit 35 and the monochrome display control data transmission and/or reception unit 45 transmit and/or receive the monochrome display control data between each other through a bus 60 via a controller 12. In other words, the monochrome display control data transmission and/or reception unit 35 transmits the monochrome display control data corresponding to the divided video sections A and C to the monochrome display control data transmission and/or reception unit 45. Further, the monochrome display control data transmission and/or reception unit 35 receives the monochrome display control data corresponding to the divided video sections B and D from the monochrome display control data transmission and/or reception unit 45. This makes it possible for the monochrome display control data transmission and/or reception unit 35 to obtain the monochrome display control data corresponding to the divided video sections A to D.

Then, the monochrome display control data transmission and/or reception unit 35 transmits the monochrome liquid crystal control signal Sig_MC including the monochrome display control data corresponding to the divided video sections A to D, to the third monochrome liquid crystal TCON 54.

Likewise, the monochrome display control data transmission and/or reception unit 45 transmits the monochrome display control data corresponding to the divided video sections B and D to the monochrome display control data transmission and/or reception unit 35. Further, the monochrome display control data transmission and/or reception unit 45 receives the monochrome display control data corresponding to the divided video sections A and C from the monochrome display control data transmission and/or reception unit 35. This makes it possible for the monochrome display control data transmission and/or reception unit 45 to obtain the monochrome display control data corresponding to the divided video sections A to D. The monochrome display control data transmission and/or reception unit 45 is configured to store the monochrome display control data corresponding to the divided video sections A to D, for example, in a third storage unit 17, and configured not to transmit the above control data toward the display panel 20.

The RGB display control data for controlling the liquid crystal panel 21 includes a gray scale value for each of R, G, and B. Meanwhile, the monochrome display control data for controlling the monochrome liquid crystal panel 22 includes a gray scale value as a gray scale. Because of this, the data amount of the monochrome display control data is approximately one third the data amount of the RGB display control data. Thus, even when the monochrome display control data transmission and/or reception unit 35 and the monochrome display control data transmission and/or reception unit 45 transmit and/or receive the monochrome display control data between each other, the load applied on this data transmission and/or reception may be suppressed.

Note that in the display device 1 according to the first modified example of the first embodiment, the first video processing unit 13 is configured to transmit the monochrome liquid crystal control signal Sig_MC corresponding to all the divided video sections to the third monochrome liquid crystal TCON 54, and the second video processing unit 14 is configured not to transmit the monochrome liquid crystal control signal Sig_MC. The first video processing unit 13 is configured to transmit an RGB liquid crystal control signal Sig_CL1 for controlling the divided video sections A and C to a first liquid crystal TCON 50, and the second video processing unit 14 is configured to transmit an RGB liquid crystal control signal Sig_CL2 for controlling the divided video section B and D to a second liquid crystal TCON 51. That is, in the display device 1 according to the first modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 1 according to the first modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

As described above, in the display device 1 according to the first modified example of the first embodiment, even in the case where the display region of the liquid crystal panel 21 is divided into the plurality of sections, and the video signal for each of the sections is processed individually, the monochrome liquid crystal control signal Sig_MC may be transmitted through a single wiring line connecting the first video processing unit 13 and the third monochrome liquid crystal TCON 54.

Thus, the third monochrome liquid crystal TCON 54 may have a configuration similar to that of a case in which the video signal is processed without dividing the display region of the liquid crystal panel 21 into the plurality of sections. Accordingly, even in the case where the display region of the liquid crystal panel 21 is divided into the plurality of sections, and the video signal for each of the sections is processed individually, it is unnecessary to newly design the third monochrome liquid crystal TCON 54, thereby making it possible to suppress the increase in the manufacturing cost.

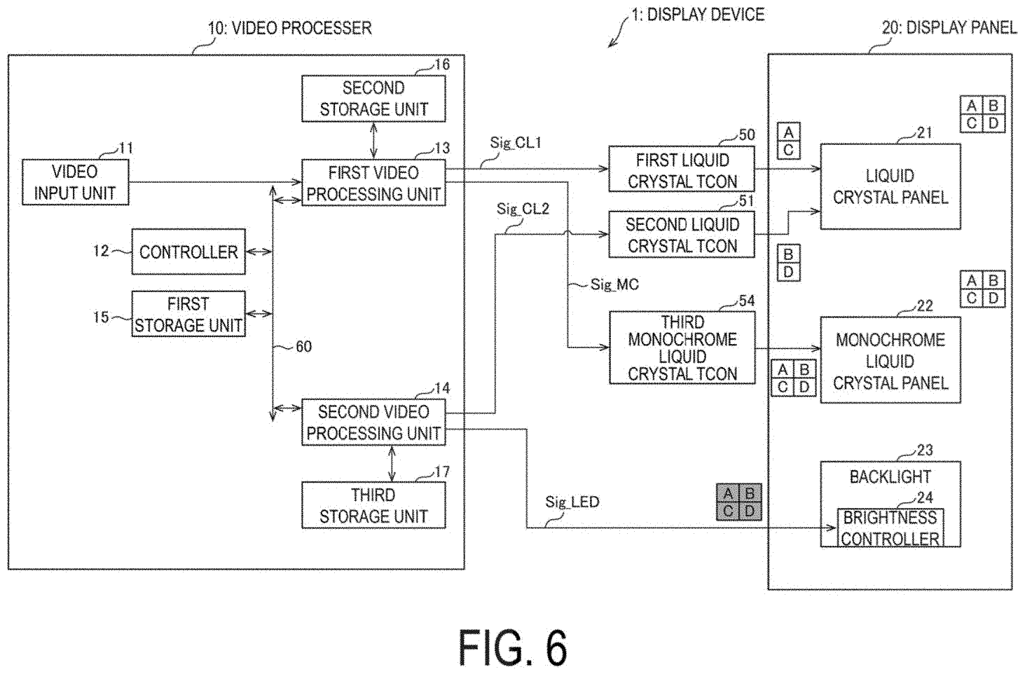

The display device 1 according to the first modified example of the first embodiment has a configuration in which the LED control signal Sig_LED is transmitted from the first video processing unit 13 to the brightness controller 24 of the backlight 23. However, as illustrated in FIG. 6, the second video processing unit 14 may transmit the LED control signal Sig_LED to the brightness controller 24 of the backlight 23. FIG. 6 is a block diagram illustrating a configuration of main portions of the display device 1 according to the first modified example of the first embodiment.

### Second Modified Example

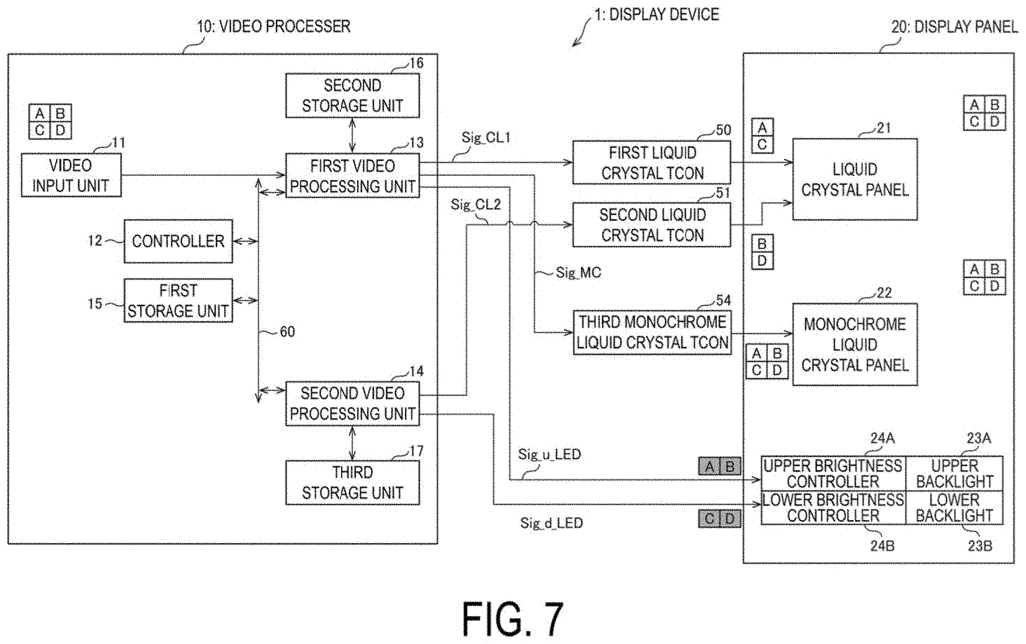

Next, a configuration of a display device 1 according to a second modified example of the first embodiment will be described with reference to FIG. 7. FIG. 7 is a block diagram illustrating a configuration of main portions of the display device 1 according to the second modified example of the first embodiment.

As illustrated in FIG. 7, the display device 1 according to the second modified example of the first embodiment is configured in such a manner that, in the configuration of the display device 1 according to the first modified example of the first embodiment, the backlight 23 is divided into two sections of an upper backlight 23A corresponding to the divided sections A and B, and a lower backlight 23B corresponding to the divided sections C and D, and each of the sections is controlled individually.

Specifically, the display device 1 according to the second modified example of the first embodiment is configured in such a manner that, in the configuration of the display device 1 according to the first modified example of the first embodiment, the backlight 23 includes the upper backlight 23A, an upper brightness controller 24A configured to control the drive of LEDs provided in the upper backlight 23A, the lower backlight 23B, and a lower brightness controller 24B configured to control the drive of LEDs provided in the lower backlight 23B.

Further, the display device 1 according to the first modified example of the first embodiment is configured in such a manner that the LED control signal Sig_LED including the LED control data for controlling all the divided sections in the backlight 23 is transmitted from the first video processing unit 13 to the brightness controller 24. In contrast, the display device 1 according to the second modified example of the first embodiment is configured in such a manner that an LED control signal Sig_u_LED for controlling the upper backlight 23A is transmitted from a first video processing unit 13 to the upper brightness controller 24A, and an LED control signal Sig_d_LED for controlling the lower backlight 23B is transmitted from a second video processing unit 14 to the lower brightness controller 24B.

As for other configurations, the display device 1 according to the second modified example of the first embodiment has the same configurations as those of the display device 1 according to the first modified example of the first embodiment. Because of this, the same constituent elements are denoted by the same reference signs and description thereof will be omitted.

That is, in the display device 1 according to the second modified example of the first embodiment, the first video processing unit 13 and the second video processing unit 14 transmit and/or receive LED control data between each other. Then, the first video processing unit 13 transmits, to the upper brightness controller 24A, the LED control signal Sig_u_LED including the LED control data for controlling the divided section A and the LED control data for controlling the divided section B. The second video processing unit 14 transmits, to the lower brightness controller 24B, the LED control signal Sig_d_LED including the LED control data for controlling the divided section C and the LED control data for controlling the divided section D.

In this manner, in the display device 1 according to the second modified example of the first embodiment, a video processer 10 controls the upper backlight 23A by causing the upper brightness controller 24A to operate with the LED control signal Sig_u_LED transmitted to the upper brightness controller 24A from the first video processing unit 13. Further, the video processer 10 controls the lower backlight 23B by causing the lower brightness controller 24B to operate with the LED control signal Sig_d_LED transmitted from the second video processing unit 14 to the lower brightness controller 24B.

The video processer 10 controls the divided video sections A and C in the liquid crystal panel 21 with an RGB liquid crystal control signal Sig_CL1 transmitted from the first video processing unit 13 to a first liquid crystal TCON 50. Further, the video processer 10 controls the divided video sections B and D in the liquid crystal panel 21 with an RGB liquid crystal control signal Sig_CL2 transmitted from the second video processing unit 14 to a second liquid crystal TCON 51. Accordingly, in the display device 1 according to the second modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 1 according to the second modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

In the display device 1 according to the second modified example of the first embodiment, the backlight 23 is configured to include the upper backlight 23A, the lower backlight 23B, the upper brightness controller 24A, and the lower brightness controller 24B. However, the backlight 23 may be configured in such a manner that a left backlight corresponding to the divided sections A and C and a right backlight corresponding to the divided sections B and D are individually controlled. In other words, the backlight 23 may be configured to include the left backlight, a left brightness controller configured to control the drive of LEDs provided in the left backlight, the right backlight, and a right brightness controller configured to control the drive of LEDs provided in the right backlight.

### Third Modified Example

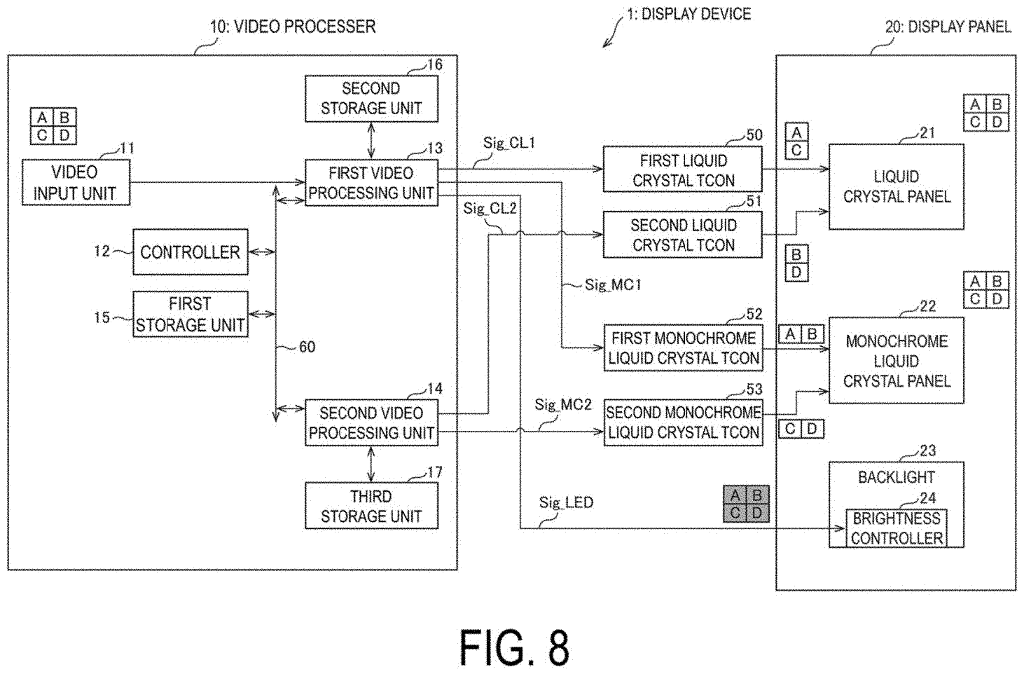

Next, a configuration of a display device 1 according to a third modified example of the first embodiment will be described with reference to FIG. 8. FIG. 8 is a block diagram illustrating a configuration of main portions of the display device 1 according to the third modified example of the first embodiment.

As illustrated in FIG. 8, the display device 1 according to the third modified example of the first embodiment has the same configuration as that of the display device 1 according to the first embodiment, but a monochrome liquid crystal control signal transmitted from the first video processing unit 13 to each of a first monochrome liquid crystal TCON 52 and a second monochrome liquid crystal TCON 53 is different.

In the display device 1 according to the third modified example of the first embodiment, similar to the display device 1 according to the first modified example of the first embodiment, the first video processing unit 13 includes the monochrome display control data transmission and/or reception unit 35, and the second video processing unit 14 includes the monochrome display control data transmission and/or reception unit 45. The monochrome display control data transmission and/or reception unit 35 and the monochrome display control data transmission and/or reception unit 45 are configured to transmit and/or receive monochrome display control data between each other.

That is, in the display device 1 according to the third modified example of the first embodiment, the monochrome display control data transmission and/or reception unit 35 receives the monochrome display control data corresponding to the divided video sections A and C in the monochrome liquid crystal panel 22 from the display control data calculation unit 34. Further, the monochrome display control data transmission and/or reception unit 35 obtains the monochrome display control data corresponding to the divided video sections B and D by mutually transmitting and/or receiving the monochrome display control data with the monochrome display control data transmission and/or reception unit 45. Then, the monochrome display control data transmission and/or reception unit 35 transmits a monochrome liquid crystal control signal Sig_MC1 including the monochrome display control data corresponding to each of the divided video sections A and B, to the first monochrome liquid crystal TCON 52.

Likewise, the monochrome display control data transmission and/or reception unit 45 receives the monochrome display control data corresponding to the divided video sections B and D in the monochrome liquid crystal panel 22 from the display control data calculation unit 44. Further, the monochrome display control data transmission and/or reception unit 45 obtains the monochrome display control data corresponding to the divided video sections A and C by mutually transmitting and/or receiving the monochrome display control data with the monochrome display control data transmission and/or reception unit 35. Then, the monochrome display control data transmission and/or reception unit 45 transmits a monochrome liquid crystal control signal Sig_MC2 including the monochrome display control data corresponding to each of the divided video sections C and D, to the second monochrome liquid crystal TCON 53.

In this manner, in the display device 1 according to the third modified example of the first embodiment, the video processer 10 controls the sections corresponding to the divided video sections A and B in the monochrome liquid crystal panel 22 with the monochrome liquid crystal control signal Sig_MC1 transmitted from the first video processing unit 13 to the first monochrome liquid crystal TCON 52. Further, the video processer 10 controls the sections corresponding to the divided video sections C and D in the monochrome liquid crystal panel 22 with the monochrome liquid crystal control signal Sig_MC2 transmitted from the second video processing unit 14 to the second monochrome liquid crystal TCON 53.

The video processer 10 controls the divided video sections A and C in the liquid crystal panel 21 with an RGB liquid crystal control signal Sig_CL1 transmitted from the first video processing unit 13 to a first liquid crystal TCON 50. Further, the divided video sections B and D in the liquid crystal panel 21 are controlled with an RGB liquid crystal control signal Sig_CL2 transmitted from the second video processing unit 14 to a second liquid crystal TCON 51.

The video processer 10 controls all the divided sections in the backlight 23 with an LED control signal Sig_LED transmitted from the first video processing unit 13 to the brightness controller 24. That is, the display device 1 according to the third modified example of the first embodiment is configured in such a manner that the pattern of sections in the liquid crystal panel 21, the pattern of sections in the monochrome liquid crystal panel 22, and the pattern of sections in the backlight 23, which are controlled by the first video processing unit 13, are different from one another. In other words, in the display device 1 according to the third modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 1 according to the third modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

### Fourth Modified Example

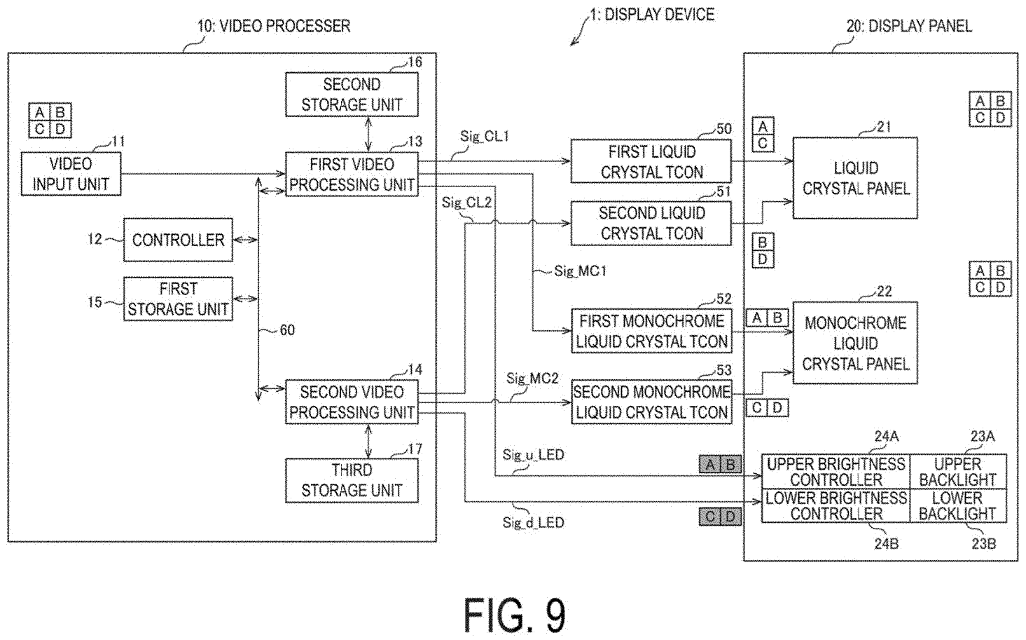

Next, a display device 1 according to a fourth modified example of the first embodiment will be described with reference to FIG. 9. FIG. 9 is a block diagram illustrating a configuration of main portions of the display device 1 according to the fourth modified example of the first embodiment.

As illustrated in FIG. 9, the display device 1 according to the fourth modified example of the first embodiment is configured in such a manner that, in the configuration of the display device 1 according to the third modified example of the first embodiment, the backlight 23 is divided into an upper backlight 23A (divided sections A and B) and a lower backlight 23B (divided sections C and D), and each of the upper and lower backlights is controlled individually.

Specifically, the display device 1 according to the fourth modified example of the first embodiment is such that, in the configuration of the display device 1 according to the third modified example of the first embodiment, the backlight 23 includes an upper backlight 23A, an upper brightness controller 24A configured to control the light emission of LEDs provided in the upper backlight 23A, a lower backlight 23B, and a lower brightness controller 24B configured to control the light emission of LEDs provided in the lower backlight 23B.

The display device 1 according to the third modified example of the first embodiment is configured in such a manner that the LED control signal Sig_LED including the LED control data for controlling all the divided sections in the backlight 23 is transmitted from the first video processing unit 13 to the brightness controller 24. In contrast, the display device 1 according to the fourth modified example of the first embodiment is configured in such a manner that an LED control signal Sig_u_LED for controlling the upper backlight 23A is transmitted from a first video processing unit 13 to the upper brightness controller 24A, and an LED control signal Sig_d_LED for controlling the lower backlight 23B is transmitted from a second video processing unit 14 to the lower brightness controller 24B.

As for other configurations, the display device 1 according to the fourth modified example of the first embodiment has the same configurations as those of the display device 1 according to the third modified example of the first embodiment. Because of this, the same constituent elements are denoted by the same reference signs and description thereof will be omitted.

That is, in the display device 1 according to the fourth modified example of the first embodiment, the first video processing unit 13 and the second video processing unit 14 transmit and/or receive LED control data between each other. Then, the first video processing unit 13 transmits, to the upper brightness controller 24A, the LED control signal Sig_u_LED including the LED control data for controlling the divided sections A and B. The second video processing unit 14 transmits, to the lower brightness controller 24B, the LED control signal Sig_d_LED including the LED control data for controlling the divided sections C and D.

In this manner, in the display device 1 according to the fourth modified example of the first embodiment, a video processer 10 controls the upper backlight 23A by causing the upper brightness controller 24A to operate with the LED control signal Sig_u_LED transmitted to the upper brightness controller 24A from the first video processing unit 13. The lower backlight 23B is controlled by causing the lower brightness controller 24B to operate with the LED control signal Sig_d_LED transmitted from the second video processing unit 14 to the lower brightness controller 24B.

The video processer 10 controls the divided video sections A and C in the liquid crystal panel 21 with an RGB liquid crystal control signal Sig_CL1 transmitted from the first video processing unit 13 to a first liquid crystal TCON 50. Further, the divided video sections B and D in the liquid crystal panel 21 are controlled with an RGB liquid crystal control signal Sig_CL2 transmitted from the second video processing unit 14 to a second liquid crystal TCON 51. Accordingly, in the display device 1 according to the fourth modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 1 according to the fourth modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

In the display device 1 according to the first embodiment and the display device 1 according to each of the first to fourth modified examples of the first embodiment, the LED control data transmission and/or reception unit 32 and the LED control data transmission and/or reception unit 42 are configured to transmit and/or receive the LED control data between each other via the controller 12 through the bus 60.

In the display device 1 according to each of the first to fourth modified examples of the first embodiment, the monochrome display control data transmission and/or reception unit 35 and the monochrome display control data transmission and/or reception unit 45 are configured to transmit and/or receive the monochrome display control data between each other via the controller 12 through the bus 60.

The transmission and/or reception of the LED control data and the monochrome display control data is not limited to the configuration in which the transmission and/or reception thereof is performed via the controller 12 as described above.

For example, the first video processing unit 13 and the second video processing unit 14 may each include a single chip microcomputer, and may be configured to transmit and/or receive the LED control data and the monochrome display control data between their single chip microcomputers through the bus 60.

Alternatively, the first video processing unit 13 and the second video processing unit 14 may be configured to include a communication interface for data transmission and/or reception through which the above video processing units may be communicatively connected to each other. The first video processing unit 13 and the second video processing unit 14 may be configured to transmit and/or receive the LED control data and the monochrome display control data directly between them.

As described above, in the display device 1 according to the first embodiment, as illustrated in FIG. 1, the first video processing unit 13 is configured to control the divided video sections A and C in the liquid crystal panel 21, and also control the sections corresponding to the divided video sections A and C in the monochrome liquid crystal panel 22. Further, the second video processing unit 14 is configured to control the divided video sections B and D in the liquid crystal panel 21, and also control the sections corresponding to the divided video sections B and D in the monochrome liquid crystal panel 22. Furthermore, the first video processing unit 13 is configured to control all the divided sections in the backlight 23, and the second video processing unit 14 is configured not to transmit the LED control signal Sig_LED to the backlight 23. In the case where the LED control signal Sig_LED is not transmitted from the second video processing unit 14 to the backlight 23, no section in the backlight 23 is controlled by the second video processing unit 14. As discussed above, in the display device 1 according to the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

In the display device 1 according to the first modified example of the first embodiment, as illustrated in FIG. 4, the first video processing unit 13 is configured to control the divided video sections A and C in the liquid crystal panel 21. The second video processing unit 14 is configured to control the divided video sections B and D in the liquid crystal panel 21. The first video processing unit 13 is configured to control the sections corresponding to all of the divided video sections A, B, C, and D in the monochrome liquid crystal panel 22, and also control all of the divided sections A, B, C, and D in the backlight 23. Meanwhile, from the second video processing unit 14, the monochrome liquid crystal control signal Sig_MC is not transmitted to the monochrome liquid crystal panel 22, and the LED control signal Sig_LED is not transmitted to the backlight 23. In the case where the monochrome liquid crystal control signal Sig_MC is not transmitted from the second video processing unit 14 to the monochrome liquid crystal panel 22, no section in the monochrome liquid crystal panel 22 is controlled by the second video processing unit 14. In the case where the LED control signal Sig_LED is not transmitted from the second video processing unit 14 to the backlight 23, no section in the backlight 23 is controlled by the second video processing unit 14. Further, as illustrated in FIG. 6, in the case where the LED control signal Sig_LED is not transmitted from the first video processing unit 13 to the backlight 23, no section in the backlight 23 is controlled by the first video processing unit 13. As discussed above, in the display device 1 according to the first modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 1 according to the first modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

In the display device 1 according to the second modified example of the first embodiment, as illustrated in FIG. 7, the first video processing unit 13 is configured to control the divided video sections A and C in the liquid crystal panel 21, and the second video processing unit 14 is configured to control the divided video sections B and D in the liquid crystal panel 21. Further, the first video processing unit 13 is configured to control the sections corresponding to all of the divided video sections A, B, C, and D in the monochrome liquid crystal panel 22, and the second video processing unit 14 is configured not to transmit the monochrome liquid crystal control signal Sig_MC to the monochrome liquid crystal panel 22. Furthermore, the first video processing unit 13 is configured to control the upper backlight 23A (divided sections A and B), and the second video processing unit 14 is configured to control the lower backlight 23B (divided sections C and D).

As discussed above, in the display device 1 according to the second modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 1 according to the second modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

In the display device 1 according to the third modified example of the first embodiment, as illustrated in FIG. 8, the first video processing unit 13 is configured to control the divided video sections A and C in the liquid crystal panel 21. The second video processing unit 14 is configured to control the divided video sections B and D in the liquid crystal panel 21. The first video processing unit 13 is configured to control the sections corresponding to the divided video sections A and B in the monochrome liquid crystal panel 22. The second video processing unit 14 is configured to control the sections corresponding to the divided video sections C and D in the monochrome liquid crystal panel 22. Furthermore, the first video processing unit 13 is configured to control all of the divided sections A, B, C, and D in the backlight 23, and the second video processing unit 14 is configured not to transmit the LED control signal Sig_LED to the backlight 23.

As discussed above, in the display device 1 according to the third modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 1 according to the third modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

In the display device 1 according to the fourth modified example of the first embodiment, as illustrated in FIG. 9, the first video processing unit 13 is configured to control the divided video sections A and C in the liquid crystal panel 21. The second video processing unit 14 is configured to control the divided video sections B and D in the liquid crystal panel 21. The first video processing unit 13 is configured to control the sections corresponding to the divided video sections A and B in the monochrome liquid crystal panel 22. The second video processing unit 14 is configured to control the sections corresponding to the divided video sections C and D in the monochrome liquid crystal panel 22. Further, the first video processing unit 13 is configured to control the upper backlight 23A (divided sections A and B), and the second video processing unit 14 is configured to control the lower backlight 23B (divided sections C and D).

As discussed above, in the display device 1 according to the fourth modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 1 according to the fourth modified example of the first embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

As described above, in the display device 1 according to the first embodiment and the display device 1 according to each of the first to fourth modified examples of the first embodiment, when at least two units of the liquid crystal panel 21, the monochrome liquid crystal panel 22, and the backlight 23 are compared with each other, the pattern of the sections controlled by the first video processing unit 13 and the pattern of the sections controlled by the second video processing unit 14 are different from each other.

Thus, in the display device 1, a substrate configured to control each of the liquid crystal panel 21, the monochrome liquid crystal panel 22, and the backlight 23 may be appropriately arranged in such a manner that terminal positions, wiring lines, and the like of the liquid crystal panel 21, the monochrome liquid crystal panel 22, and the backlight 23 do not overlap with one another. Further, the display device 1 may use, as a substrate thereof, a brightness control substrate, a TCON substrate, or the like that is used in a display device configured to process video signals without dividing the display region of a liquid crystal panel into a plurality of sections (hereinafter, referred to as a display device 1000 according to a comparative example); in such a case, it is unnecessary to newly design a substrate, and it is possible to reduce the manufacturing cost. Substrate arrangement of the display device 1 is described below.

### Substrate Arrangement

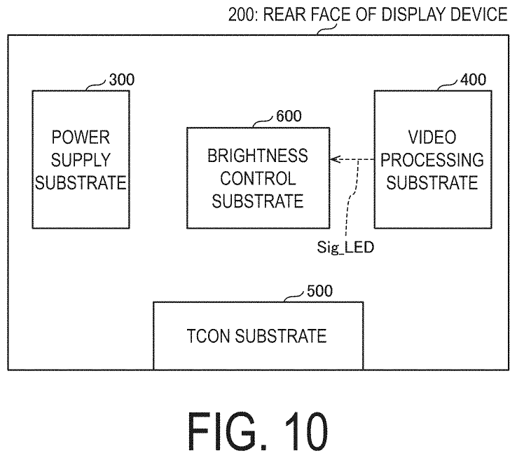

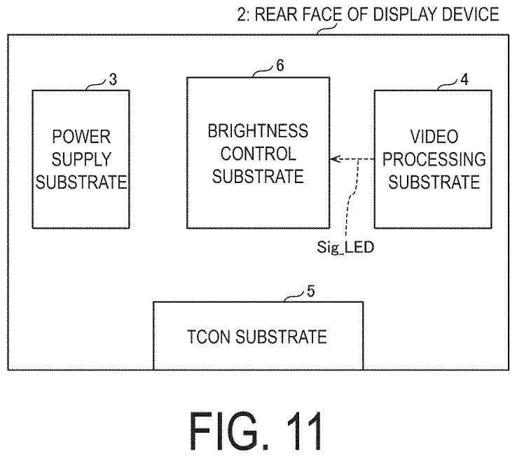

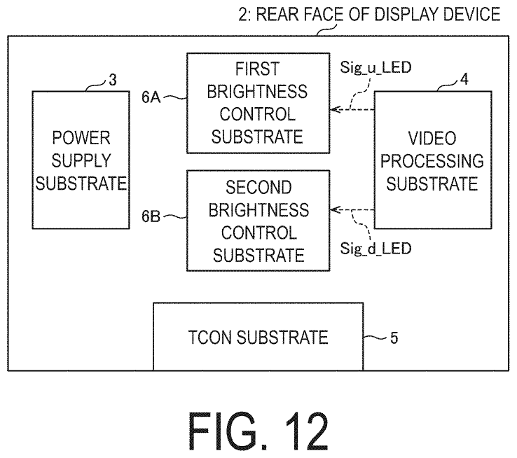

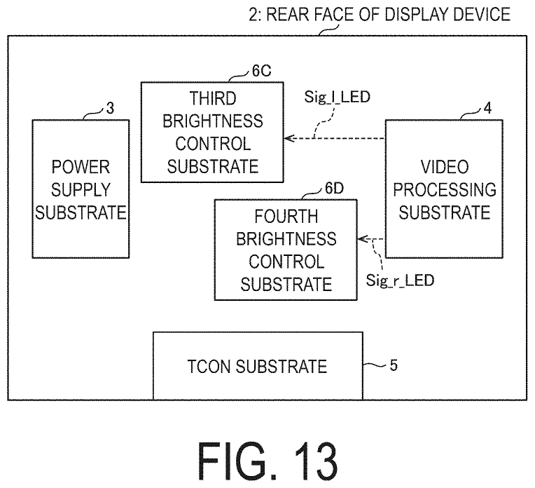

Hereinafter, substrate arrangement on a rear face 2 of the display device 1 according to the first embodiment will be described with reference to FIG. 10 to FIG. 13. FIG. 10 is a diagram illustrating an example of substrate arrangement on a rear face 200 of the display device 1000 according to the comparative example. The display device 1000 according to the comparative example is, for example, a display device having a 4K resolution. FIG. 11 is a diagram illustrating an example of the substrate arrangement on the rear face 2 of the display device 1 according to the first embodiment. FIGS. 12 and 13 are diagrams each illustrating an example of substrate arrangement on a rear face 2 of a display device 1 according to a modified example of the first embodiment. In each of FIGS. 12 and 13, a configuration in which the backlight 23 is divided into a plurality of sections is cited as an example, and the substrate arrangement on the rear face 2 of the display device 1 is described.

As illustrated in FIG. 10, a power supply substrate 300, a video processing substrate 400, a TCON substrate 500, and a brightness control substrate 600 are arranged on the rear face 200 of the display device 1000 according to the comparative example.

The power supply substrate 300 is a substrate for supplying power to the display device. The video processing substrate 400 is a substrate on which a video processing circuit is mounted. The TCON substrate 500 is a substrate on which a circuit constituting a timing controller is mounted. The brightness control substrate 600 is a substrate on which a circuit for controlling the backlight is mounted.

Meanwhile, as illustrated in FIG. 11, in the display device 1 according to the first embodiment, a power supply substrate 3, a video processing substrate 4, a TCON substrate 5, and a brightness control substrate 6 are arranged on the rear face 2 of the display device 1.

The power supply substrate 3 is a substrate for supplying power to the display device 1. The video processing substrate 4 is a substrate on which a circuit constituting the video processer 10 is mounted. The TCON substrate 5 is a substrate on which a circuit constituting timing controllers such as the first liquid crystal TCON 50, the second liquid crystal TCON 51, the first monochrome liquid crystal TCON 52, and the second monochrome liquid crystal TCON 53 is mounted. The brightness control substrate 6 is a substrate on which a circuit constituting the brightness controller 24 is mounted.

In the display device 1 according to the first embodiment, the brightness controller 24 is configured to control the drive of all the LEDs provided in the backlight 23 based on the LED control signal Sig_LED received from the video processer 10. Then, in the display device 1 according to the first embodiment, as illustrated in FIG. 11, the brightness control substrate 6 constituting the brightness controller 24 is arranged substantially in the center of the rear face 2 of the display device 1.

Here, the display device 1 according to the first embodiment is configured to increase the number of divided regions of the backlight as compared to the conventional display device 1000. In the case of such a configuration, the brightness control substrate 6 of the display device 1 according to the first embodiment may cope with the increased number of divided regions of the backlight by expanding the size of the substrate itself as compared to the brightness control substrate 600 of the conventional display device 1000.

Further, for example, as in the display device 1 according to the second modified example of the first embodiment, in the configuration in which the light emission of the LEDs provided in the upper backlight 23A is controlled by the upper brightness controller 24A and the light emission of the LEDs provided in the lower backlight 23B is controlled by the lower brightness controller 24B, that is, in the configuration in which the backlight 23 is divided into the upper and lower portions and controlled, the display device 1 may take the substrate arrangement, as illustrated in FIG. 12, on the rear face 2. In other words, on the rear face 2 of the display device 1, the brightness control substrate 6 is divided into two substrates of a first brightness control substrate 6A constituting the upper brightness controller 24A and a second brightness control substrate 6B constituting the lower brightness controller 24B. Then, the first brightness control substrate 6A is arranged on the second brightness control substrate 6B. From the video processing substrate 4, an LED control signal Sig_u_LED is input to the first brightness control substrate 6A, and an LED control signal Sig_d_LED is input to the second brightness control substrate 6B. In this manner, by arranging the first brightness control substrate 6A and the second brightness control substrate 6B being set on the upper and lower sides respectively, it is easy to carry out wiring on the backlight 23 divided into the upper and lower portions. As discussed above, even in the case of a configuration in which the backlight 23 is divided into a plurality of sections and controlled, for example, a configuration in which the backlight 23 is divided into the upper backlight 23A and the lower backlight 23B and controlled, the brightness control substrate 600 of the display device 1000 according to the comparative example may be used as the first brightness control substrate 6A and the second brightness control substrate 6B as long as the number of divided regions in the sections of the upper backlight 23A as well as the number of divided regions in the sections of the lower backlight 23B is smaller than or equal to the number of divided regions in the backlight of the display device 1000 according to the comparative example.

Furthermore, for example, in a configuration in which the backlight 23 is divided into a left portion and a right portion and controlled, substrate arrangement illustrated in FIG. 13 may be employed on the rear face 2 of the display device 1. In other words, on the rear face 2 of the display device 1, the brightness control substrate 6 is divided into two substrates of a third brightness control substrate 6C constituting a left brightness controller and a fourth brightness control substrate 6D constituting a right brightness controller. Then, the substrate arrangement is carried out in such a manner that the third brightness control substrate 6C is shifted to the left side while the fourth brightness control substrate 6D is shifted to the right side. From the video processing substrate 4, an LED control signal Sig_l_LED is input to the third brightness control substrate 6C, and an LED control signal Sig_r_LED is input to the fourth brightness control substrate 6D. In this manner, by arranging the third brightness control substrate 6C and the fourth brightness control substrate 6D being shifted to the left and right sides respectively, it is easy to carry out wiring on the backlight 23 being divided into the left and right portions. As discussed above, even in the case of a configuration in which the backlight 23 is divided into the plurality of sections and controlled, for example, a configuration in which the backlight 23 is divided into the left backlight 23C and the right backlight 23D and controlled, the brightness control substrate 600 of the display device 1000 according to the comparative example may be used as the third brightness control substrate 6C and the fourth brightness control substrate 6D as long as the number of divided regions in the sections of the right portion of the backlight as well as the number of divided regions in the sections of the left portion of the backlight is smaller than or equal to the number of divided regions in the backlight of the display device 1000 according to the comparative example.

As discussed above, in the case of a configuration in which the drive of the LEDs provided in the backlight 23 is controlled while being divided into the plurality of sections such as the upper and lower portions or the left and right portions, the brightness control substrate 6 may be divided into the plurality of substrates, and each of the substrates may be adequately arranged. As a result, it is possible to increase the degree of freedom of wiring of the cables connecting each of the substrates on the rear face 2 of the display device 1.

In the case of the configuration in which the drive of the LEDs provided in the backlight 23 is controlled while being divided into the plurality sections such as the upper and lower portions or the left and right portions, the brightness control substrate 600 used in the display device 1000 according to the comparative example may be used without any change. With this, it is unnecessary to newly design a substrate, so that the manufacturing cost may be reduced.

Here, an example is described in which the brightness control substrate 6 is divided into the upper and lower portions or the left and right portions and arranged, and the situation is the same in the liquid crystal panel 21 and the monochrome liquid crystal panel 22 from the perspective that the circuit arrangement may be changed in accordance with a pattern of sections to be controlled.

Accordingly, it is possible to design the substrate arrangement in such a manner as to reduce overlap of wiring of the cables connecting each of the substrates by causing the patterns of at least two sections to differ from each other among the patterns including the pattern of the sections (divided video sections) in the liquid crystal panel 21, the pattern of the sections in the monochrome liquid crystal panel 22, and the pattern of the sections (divided sections) in the backlight 23, which are controlled by the video processer 10.

In the case of the configuration in which the liquid crystal panel 21 and the monochrome liquid crystal panel 22 are each divided into the plurality of sections and controlled, the TCON substrate 500 used in the display device 1000 according to the comparative example may be used without any change. With this, it is unnecessary to newly design a substrate, so that the manufacturing cost may be reduced.

### Second Embodiment

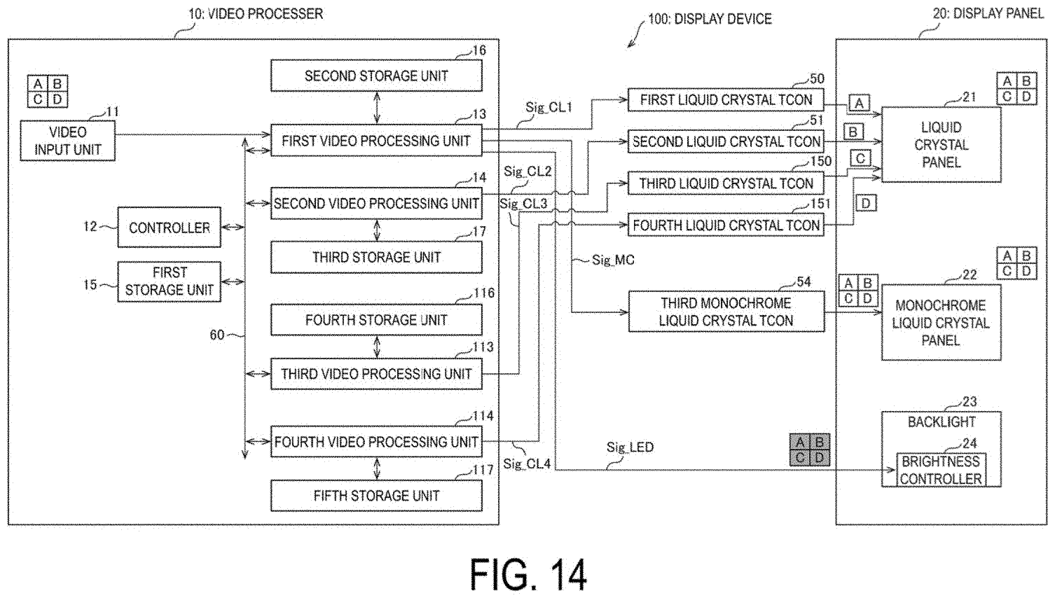

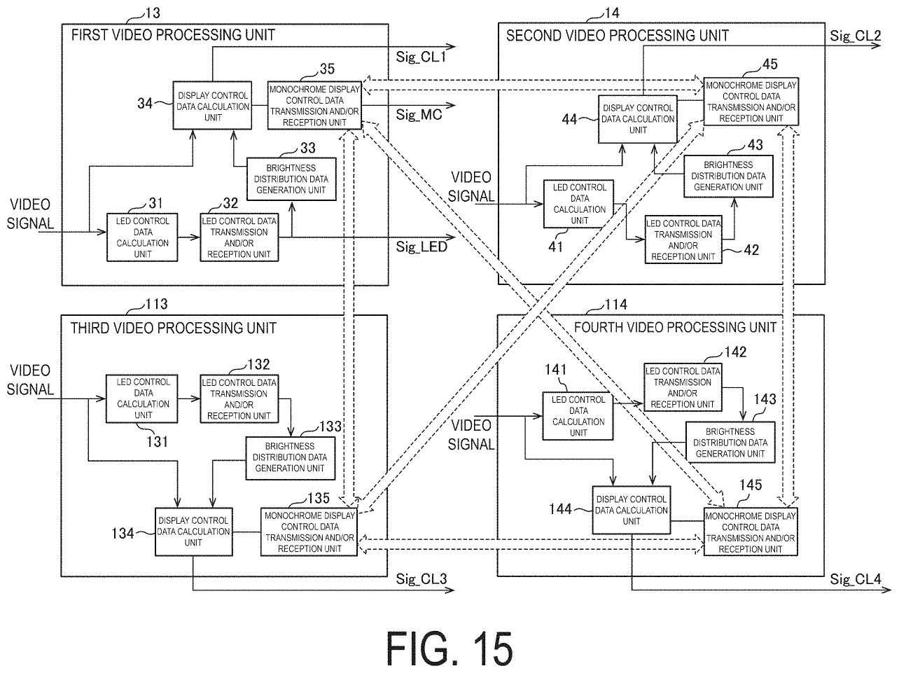

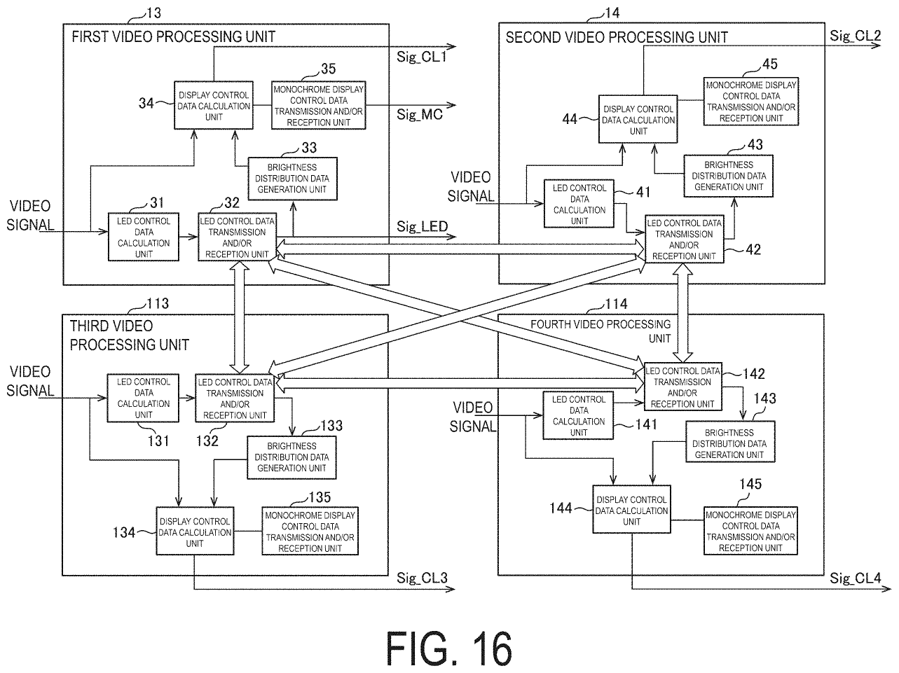

With reference to FIGS. 14, 15, and 16, a display device 100 according to a second embodiment of the disclosure will be described. FIG. 14 is a block diagram illustrating a configuration of main portions of the display device 100 according to the second embodiment. FIGS. 15 and 16 are each a block diagram illustrating a configuration of main portions of a video processer 10 included in the display device 100 according to the second embodiment. In each of FIGS. 15 and 16, in the video processer 10, the configuration of main portions of a first video processing unit 13, a second video processing unit 14, a third video processing unit 113, and a fourth video processing unit 114 is specifically illustrated. In FIG. 15, the flows of monochrome display control data transmitted and/or received between the first video processing unit 13, the second video processing unit 14, the third video processing unit 113, and the fourth video processing unit 114 are indicated by broken line arrows. On the other hand, in FIG. 16, the flows of LED control data transmitted and/or received between the first video processing unit 13, the second video processing unit 14, the third video processing unit 113, and the fourth video processing unit 114 are indicated by solid line arrows.

As illustrated in FIG. 14, the display device 100 includes the video processer 10, a display panel 20, a first liquid crystal TCON 50, a second liquid crystal TCON 51, a third liquid crystal TCON 150, a fourth liquid crystal TCON 151, and a third monochrome liquid crystal TCON 54.

The display device 100 according to the second embodiment further includes the third liquid crystal TCON 150 and the fourth liquid crystal TCON 151 in addition to the first liquid crystal TCON 50 and the second liquid crystal TCON 51 in the configuration of the display device 1 according to the first embodiment. Further, the third monochrome liquid crystal TCON 54 is provided in place of the first monochrome liquid crystal TCON 52 and the second monochrome liquid crystal TCON 53.

The video processer 10 further includes the third video processing unit 113 and the fourth video processing unit 114 in addition to the first video processing unit 13 and the second video processing unit 14 in the configuration of the video processer 10 according to the first embodiment. Further, in addition to the second storage unit 16 and the third storage unit 17, a fourth storage unit 116 and a fifth storage unit 117 are provided. The first video processing unit 13 and the second storage unit 16 are communicably connected to each other, and various data to be used in the first video processing unit 13 is stored in the second storage unit 16. The second video processing unit 14 and the third storage unit 17 are communicably connected to each other, and various data to be used in the second video processing unit 14 is stored in the third storage unit 17. The third video processing unit 113 and the fourth storage unit 116 are communicably connected to each other, and various data to be used in the third video processing unit 113 is stored in the fourth storage unit 116. The fourth video processing unit 114 and the fifth storage unit 117 are communicably connected to each other, and various data to be used in the fourth video processing unit 114 is stored in the fifth storage unit 117.

As described above, the display device 100 according to the second embodiment has a configuration similar to that of the display device 1 according to the first embodiment except that the number of video processing units included in the video processer 10 and the number of liquid crystal TCONs are each increased to be four, the number of storage units included in the video processer 10 is increased to be five, and the third monochrome liquid crystal TCON 54 is provided. Because of this, the same constituent elements are denoted by the same reference signs and description thereof will be omitted.

As illustrated in FIG. 15, the first video processing unit 13 includes an LED control data calculation unit 31, an LED control data transmission and/or reception unit 32, a brightness distribution data generation unit 33, a display control data calculation unit 34, and a monochrome display control data transmission and/or reception unit 35. Description of each of these units included in the first video processing unit 13 will be omitted because the description thereof has been described in the first embodiment.

The second video processing unit 14 includes an LED control data calculation unit 41, an LED control data transmission and/or reception unit 42, a brightness distribution data generation unit 43, a display control data calculation unit 44, and a monochrome display control data transmission and/or reception unit 45. Description of each of these units included in the second video processing unit 14 will be omitted because the description thereof has been described in the first embodiment.

The third video processing unit 113 includes an LED control data calculation unit 131, an LED control data transmission and/or reception unit 132, a brightness distribution data generation unit 133, a display control data calculation unit 134, and a monochrome display control data transmission and/or reception unit 135. The above-mentioned units included in the third video processing unit 113 are similar to the LED control data calculation unit 41, the LED control data transmission and/or reception unit 42, the brightness distribution data generation unit 43, the display control data calculation unit 44, and the monochrome display control data transmission and/or reception unit 45, which are included in the second video processing unit 14, and therefore the description thereof will be omitted.

The fourth video processing unit 114 includes an LED control data calculation unit 141, an LED control data transmission and/or reception unit 142, a brightness distribution data generation unit 143, a display control data calculation unit 144, and a monochrome display control data transmission and/or reception unit 145. The above-mentioned units included in the fourth video processing unit 114 are similar to the LED control data calculation unit 41, the LED control data transmission and/or reception unit 42, the brightness distribution data generation unit 43, the display control data calculation unit 44, and the monochrome display control data transmission and/or reception unit 45, which are included in the second video processing unit 14, and therefore the description thereof will be omitted.

In the display device 100 according to the second embodiment, a video input unit 11 transmits an input video signal to the first video processing unit 13. The first video processing unit 13 receives, from the video input unit 11, video signals of videos to be displayed on the divided video sections A, B, C, and D in a liquid crystal panel 21. Then, the first video processing unit 13 transmits a video signal of the video to be displayed on the upper right section (divided video section B) of the liquid crystal panel 21 to the second video processing unit 14 through a bus 60 via a controller 12. The first video processing unit 13 transmits a video signal of the video to be displayed on the lower left section (divided video sections C) of the liquid crystal panel 21 to the third video processing unit 113 through the bus 60 via the controller 12. The first video processing unit 13 transmits a video signal of the video to be displayed on the lower right section (divided video section D) of the liquid crystal panel 21 to the fourth video processing unit 114 through the bus 60 via the controller 12.

This allows the first video processing unit 13 to process the video to be displayed on the divided video section A in the liquid crystal panel 21, and allows the second video processing unit 14 to process the video to be displayed on the divided video section B in the liquid crystal panel 21. Further, this allows the third video processing unit 113 to process the video to be displayed on the divided video section C in the liquid crystal panel 21, and allows the fourth video processing unit 114 to process the video to be displayed on the divided video section D in the liquid crystal panel 21.

As describe above, the display device 100 according to the second embodiment has a configuration in which the input video signal is divided into signals corresponding to the respective divided video sections A, B, C, and D, and these signals are subjected to signal processing in the video processer 10.

The video input unit 11 may be configured to transmit all of the input video signals to each of the first video processing unit 13, second video processing unit 14, third video processing unit 113, and fourth video processing unit 114. In the case of this configuration, each of the first video processing unit 13, second video processing unit 14, third video processing unit 113, and fourth video processing unit 114 may be configured to discard the video signals not to be processed among the received video signals.

The first video processing unit 13, second video processing unit 14, third video processing unit 113, and fourth video processing unit 114 each perform signal processing on the video signal of the video to be displayed on the divided video section assigned to each of the video processing units. In the second embodiment, the first video processing unit 13 performs signal processing on the video signal of the video to be displayed on the divided video section A. The second video processing unit 14 performs signal processing on the video signal of the video to be displayed on the divided video section B. The third video processing unit 113 performs signal processing on the video signal of the video to be displayed on the divided video section C. The fourth video processing unit 114 performs signal processing on the video signal of the video to be displayed on the divided video section D.

The first video processing unit 13 generates and transmits an RGB liquid crystal control signal Sig_CL1 to the liquid crystal panel 21 via the first liquid crystal TCON 50. The second video processing unit 14 generates and transmits an RGB liquid crystal control signal Sig_CL2 to the liquid crystal panel 21 via the second liquid crystal TCON 51. The third video processing unit 113 generates and transmits an RGB liquid crystal control signal Sig_CL3 to the liquid crystal panel 21 via the third liquid crystal TCON 150. The fourth video processing unit 114 generates and transmits an RGB liquid crystal control signal Sig_CL4 to the liquid crystal panel 21 via the fourth liquid crystal TCON 151.

Further, the first video processing unit 13, second video processing unit 14, third video processing unit 113, and fourth video processing unit 114 each generate monochrome display control data for controlling the sections in a monochrome liquid crystal panel 22 corresponding to each of the divided video sections controlled by the respective video processing units in the liquid crystal panel 21. Then, as illustrated in FIG. 15, the first video processing unit 13, second video processing unit 14, third video processing unit 113, and fourth video processing unit 114 transmit and/or receive the generated monochrome display control data between each other. That is, the monochrome display control data transmission and/or reception unit 35 of the first video processing unit 13, the monochrome display control data transmission and/or reception unit 45 of the second video processing unit 14, the monochrome display control data transmission and/or reception unit 135 of the third video processing unit 113, and the monochrome display control data transmission and/or reception unit 145 of the fourth video processing unit 114 transmit and/or receive the monochrome display control data between each other.

The first video processing unit 13 transmits, to the third monochrome liquid crystal TCON 54, a monochrome liquid crystal control signal Sig_MC including monochrome display control data received from each of the second video processing unit 14, the third video processing unit 113 and the fourth video processing unit 114, and monochrome display control data generated by the first video processing unit 13 itself.

The first video processing unit 13, second video processing unit 14, third video processing unit 113, and fourth video processing unit 114 each generate LED control data for controlling divided sections in a backlight 23 corresponding to the respective divided video sections to be processed by each of the first to fourth video processing units. Then, as illustrated in FIG. 16, the first video processing unit 13, second video processing unit 14, third video processing unit 113, and fourth video processing unit 114 transmit and/or receive the generated LED control data between each other. That is, the LED control data transmission and/or reception unit 32 of the first video processing unit 13, the LED control data transmission and/or reception unit 42 of the second video processing unit 14, the LED control data transmission and/or reception unit 132 of the third video processing unit 113, and the LED control data transmission and/or reception unit 142 of the fourth video processing unit 114 transmit and/or receive the LED control data between each other.

The first video processing unit 13 transmits, to the backlight 23, an LED control signal Sig_LED including the LED control data received from each of the second video processing unit 14, the third video processing unit 113 and the fourth video processing unit 114, and the LED control data generated by the first video processing unit 13 itself.

As described above, in the display device 100 according to the second embodiment, the first video processing unit 13, the second video processing unit 14, the third video processing unit 113, and the fourth video processing unit 114 respectively transmit, to the liquid crystal panel 21, the RGB liquid crystal control signals Sig_CL1, Sig_CL2, Sig_CL3, and Sig_CL4 for controlling the divided video sections to be processed by each of the video processing units. In addition, the first video processing unit 13 transmits, to the grayscale liquid crystal panel 22, the monochrome liquid crystal control signal Sig_MC for controlling the sections in the monochrome liquid crystal panel 22 corresponding to the divided video sections A, B, C, and D, and also transmits, to the backlight 23, the LED control signal Sig_LED including the LED control data for controlling the divided sections A, B, C, and D in the backlight 23 corresponding to the divided video sections.

That is, in the display device 100 according to the second embodiment, the patterns of the sections controlled by each of the first video processing unit 13, the second video processing unit 14, the third video processing unit 113, and the fourth video processing unit 114 differ from each other in the liquid crystal panel 21 and the monochrome liquid crystal panel 22, or in the liquid crystal panel 21 and the backlight 23.

Thus, in the display device 100 according to the second embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 100 according to the second embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

Other video processing units besides the first video processing unit 13 may be configured to transmit the monochrome liquid crystal control signal Sig_MC to the monochrome liquid crystal panel 22. Alternatively, other video processing units besides the first video processing unit 13 may be configured to transmit the LED control signal Sig_LED to the backlight 23. The first video processing unit 13, second video processing unit 14, third video processing unit 113, and fourth video processing unit 114 transmit and/or receive the monochrome display control data and the LED control data between each other. Due to this, any of the first video processing unit 13, the second video processing unit 14, the third video processing unit 113, and the fourth video processing unit 114 may transmit the monochrome liquid crystal control signal Sig_MC to the monochrome liquid crystal panel 22. Further, any of the first video processing unit 13, the second video processing unit 14, the third video processing unit 113, and the fourth video processing unit 114 may transmit the LED control signal Sig_LED to the backlight 23.

### First Modified Example of Second Embodiment

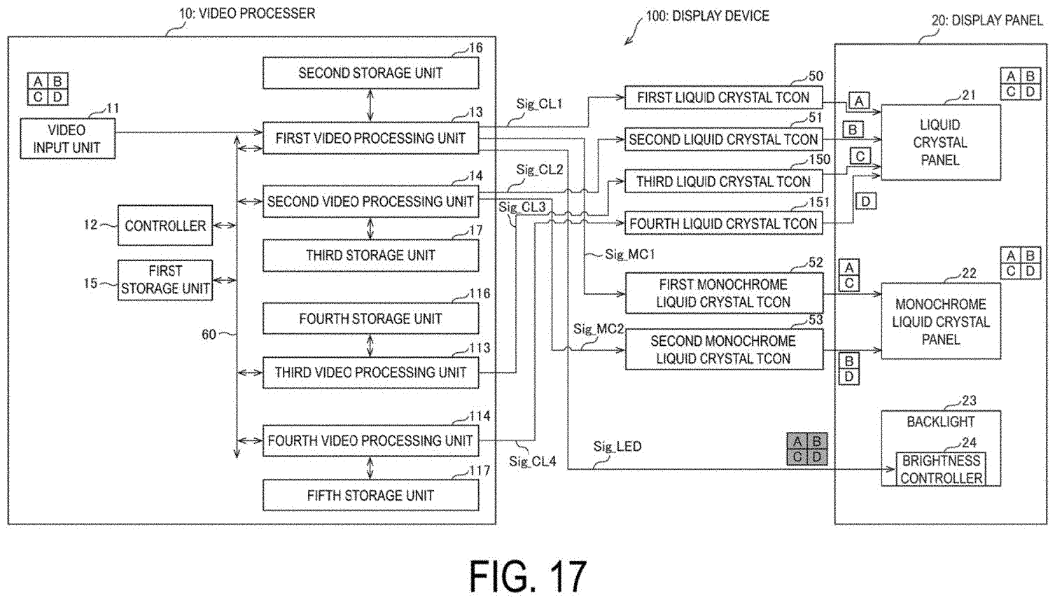

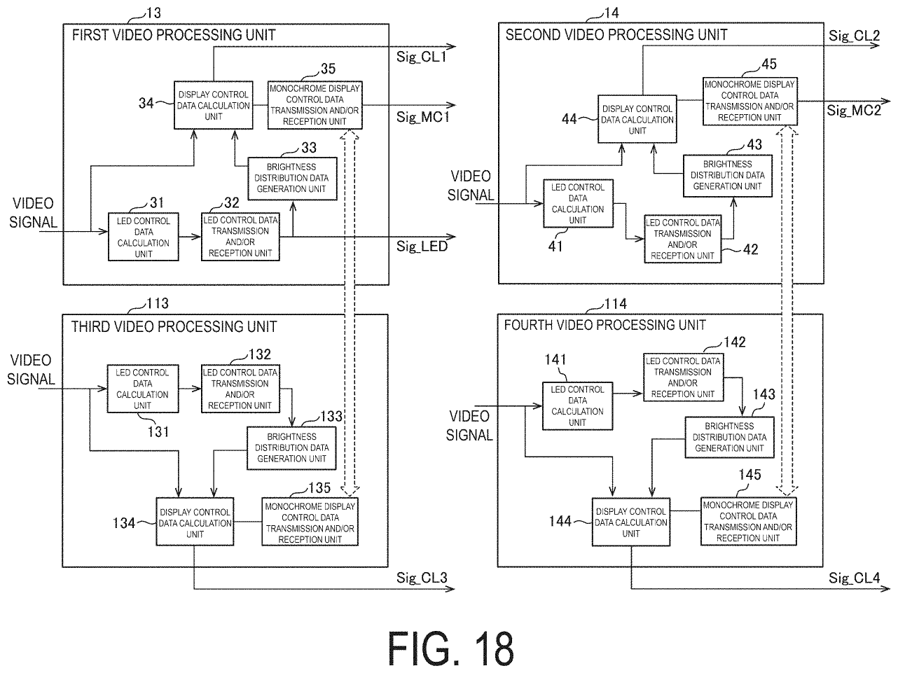

A display device 100 according to a first modified example of the second embodiment of the disclosure will be described with reference to FIGS. 17 and 18. FIG. 17 is a block diagram illustrating a configuration of main portions of the display device 100 according to the first modified example of the second embodiment. FIG. 18 is a block diagram illustrating a configuration of main portions of a video processer 10 included in the display device 100 according to the first modified example of the second embodiment. In FIG. 18, the flows of monochrome display control data transmitted and/or received between a first video processing unit 13, a second video processing unit 14, a third video processing unit 113, and a fourth video processing unit 114 are indicated by broken line arrows.

As illustrated in FIG. 17, the display device 100 according to the first modified example of the second embodiment includes a first monochrome liquid crystal TCON 52 and a second monochrome liquid crystal TCON 53 in place of the third monochrome liquid crystal TCON 54 in the configuration of the display device 100 according to the second embodiment.

The display device 100 according to the second embodiment has a configuration in which the monochrome liquid crystal control signal Sig_MC is transmitted from the first video processing unit 13 to the third monochrome liquid crystal TCON 54. In contrast, the display device 100 according to the first modified example of the second embodiment has a configuration in which a monochrome liquid crystal control signal Sig_MC1 is transmitted from the first video processing unit 13 to the first monochrome liquid crystal TCON 52, and a monochrome liquid crystal control signal Sig_MC2 is transmitted from the second video processing unit 14 to the second monochrome liquid crystal TCON 53.

Except for the above-described points, the display device 100 according to the first modified example of the second embodiment is similar to the display device 100 according to the second embodiment, and therefore similar constituent elements are denoted by the same reference signs and the description thereof will be omitted.

That is, in the display device 100 according to the first modified example of the second embodiment, the video processer 10 transmits each of an RGB liquid crystal control signal Sig_CL1 for controlling the divided video section A, an RGB liquid crystal control signal Sig_CL2 for controlling the divided video section B, an RGB liquid crystal control signal Sig_CL3 for controlling the divided video section C, and an RGB liquid crystal control signal Sig_CL4 for controlling the divided video section D, toward the liquid crystal panel 21.

The video processer 10 transmits, toward the monochrome liquid crystal panel 22, the monochrome liquid crystal control signal Sig_MC1 for controlling the sections in the monochrome liquid crystal panel 22 corresponding to the divided video sections A and C, and the monochrome liquid crystal control signal Sig_MC2 for controlling the sections in the monochrome liquid crystal panel 22 corresponding to the divided video sections B and D. Further, the video processer 10 transmits, to the backlight 23, an LED control signal Sig_LED for controlling all of the divided sections A, B, C, and D.

That is, the patterns of the sections controlled by each of the first video processing unit 13, the second video processing unit 14, the third video processing unit 113, and the fourth video processing unit 114 differ between the liquid crystal panel 21, the monochrome liquid crystal panel 22, and the backlight 23.

Specifically, as illustrated in FIG. 17, the first video processing unit 13 generates and transmits the RGB liquid crystal control signal Sig_CL1 to the liquid crystal panel 21 via a first liquid crystal TCON 50. The second video processing unit 14 generates and transmits the RGB liquid crystal control signal Sig_CL2 to the liquid crystal panel 21 via the second liquid crystal TCON 51. The third video processing unit 113 generates and transmits the RGB liquid crystal control signal Sig_CL3 to the liquid crystal panel 21 via a third liquid crystal TCON 150. The fourth video processing unit 114 generates and transmits the RGB liquid crystal control signal Sig_CL4 to the liquid crystal panel 21 via a fourth liquid crystal TCON 151.

The first video processing unit 13, second video processing unit 14, third video processing unit 113, and fourth video processing unit 114 each generate monochrome display control data for controlling the sections in the monochrome liquid crystal panel 22 corresponding to the divided video sections to be processed by each of the first to fourth video processing units. As illustrated in FIG. 18, a monochrome display control data transmission and/or reception unit 35 of the first video processing unit 13 and a monochrome display control data transmission and/or reception unit 135 of the third video processing unit 113 transmit and/or receive the generated monochrome display control data between each other. This makes it possible for the first video processing unit 13 and the third video processing unit 113 to hold the monochrome display control data corresponding to the divided video sections A and C. Then, the first video processing unit 13 generates the monochrome liquid crystal control signal Sig_MC1 including the monochrome display control data corresponding to the divided video sections A and C, and transmits the generated signal to the monochrome liquid crystal panel 22 via the first monochrome liquid crystal TCON 52.

A monochrome display control data transmission and/or reception unit 45 of the second video processing unit 14 and a monochrome display control data transmission and/or reception unit 145 of the fourth video processing unit 114 transmit and/or receive the generated monochrome display control data between each other. This makes it possible for the second video processing unit 14 and the fourth video processing unit 114 to hold the monochrome display control data corresponding to the divided video sections B and D. The second video processing unit 14 generates the monochrome liquid crystal control signal Sig_MC2 including the monochrome display control data corresponding to the divided video sections B and D, and transmits the generated signal to the monochrome liquid crystal panel 22 via the second monochrome liquid crystal TCON 53.

Although not illustrated in FIG. 18, in the display device 100 according to the first modified example of the second embodiment, similar to the display device 100 according to the second embodiment, an LED control data transmission and/or reception unit 32, an LED control data transmission and/or reception unit 42, an LED control data transmission and/or reception unit 132, and an LED control data transmission and/or reception unit 142 transmit and/or receive LED control data between each other. The first video processing unit 13 transmits, to the backlight 23, the LED control signal Sig_LED including the LED control data for controlling all of the divided sections A, B, C, and D.

That is, the patterns of the sections controlled by each of the first video processing unit 13, the second video processing unit 14, the third video processing unit 113, and the fourth video processing unit 114 differ between the liquid crystal panel 21, the monochrome liquid crystal panel 22, and the backlight 23. Accordingly, in the display device 100 according to the first modified example of the second embodiment, when the display panel 20 is viewed in a plan view, the pattern of the sections controlled by the first video processing unit 13 in the liquid crystal panel 21, the pattern of the sections controlled by the first video processing unit 13 in the monochrome liquid crystal panel 22, and the pattern of the sections controlled by the first video processing unit 13 in the backlight 23 differ from each other.

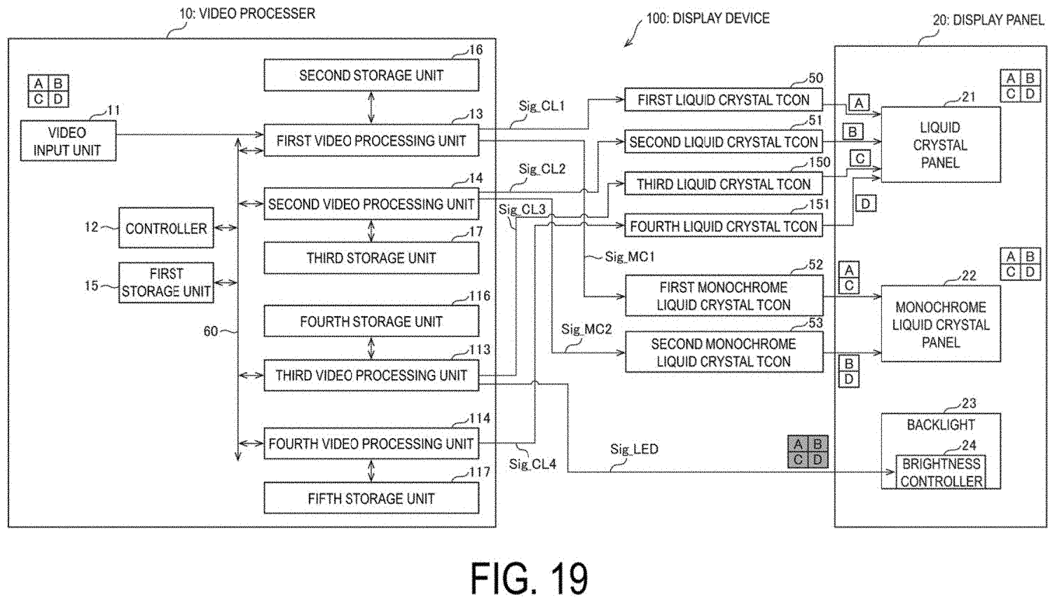

The video processing unit configured to transmit the LED control signal Sig_LED to the backlight 23 is not limited to the first video processing unit 13. For example, as illustrated in FIG. 19, the third video processing unit 113 may transmit the LED control signal Sig_LED to the backlight 23. Alternatively, the second video processing unit 14 or the fourth video processing unit 114 may transmit the LED control signal Sig_LED to the backlight 23. FIG. 19 is a block diagram illustrating a configuration of main portions of the display device 100 according to the first modified example of the second embodiment.

The display device 100 according to the first modified example of the second embodiment is configured in such a manner that the monochrome display control data is transmitted and/or received between the first video processing unit 13 and the third video processing unit 113. Further, the monochrome display control data is transmitted and/or received between the second video processing unit 14 and the fourth video processing unit 114.

However, the monochrome display control data may be transmitted and/or received between the first video processing unit 13, second video processing unit 14, third video processing unit 113, and fourth video processing unit 114. Then, the first video processing unit 13 may generate the monochrome liquid crystal control signal Sig_MC1 including the monochrome display control data for controlling the sections corresponding to the divided video sections A and C in the monochrome liquid crystal panel 22, and the second video processing unit 14 may generate the monochrome liquid crystal control signal Sig_MC2 including the monochrome display control data for controlling the sections corresponding to the divided video sections B and D in the monochrome liquid crystal panel 22.

### Second Modified Example of Second Embodiment

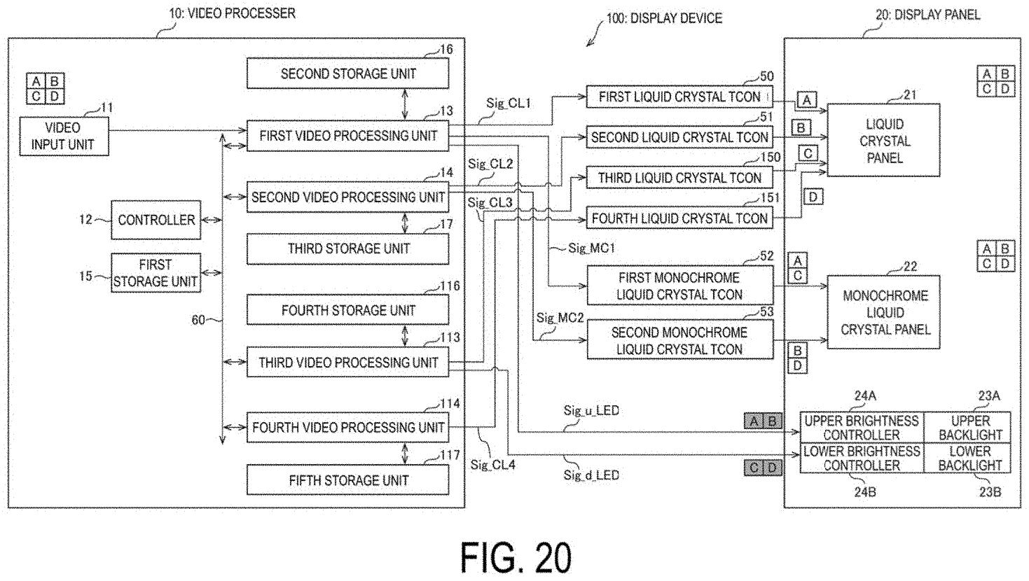

Next, a configuration of a display device 100 according to a second modified example of the second embodiment will be described with reference to FIG. 20. FIG. 20 is a block diagram illustrating a configuration of main portions of the display device 100 according to the second modified example of the second embodiment.

As illustrated in FIG. 20, the display device 100 according to the second modified example of the second embodiment is configured in such a manner that, in the configuration of the display device 100 according to the first modified example of the second embodiment, the backlight 23 is divided into an upper backlight 23A and a lower backlight 23B, which are individually controlled by a video processer 10.

Specifically, the display device 100 according to the second modified example of the second embodiment is configured to include the upper backlight 23A, an upper brightness controller 24A configured to control the light emission of LEDs provided in the upper backlight 23A, the lower backlight 23B, and a lower brightness controller 24B configured to control the light emission of LEDs provided in the lower backlight 23B in the configuration of the display device 100 according to the first modified example of the second embodiment.

Further, the display device 100 according to the first modified example of the second embodiment is configured in such a manner that the LED control signal Sig_LED including the LED control data for controlling all of the divided sections A, B, C, and D is transmitted from the first video processing unit 13 to the brightness controller 24. In contrast, in the display device 100 according to the second modified example of the second embodiment, an LED control signal Sig_u_LED for controlling the light emission of LEDs provided in the upper backlight 23A (divided sections A and B) is transmitted from a first video processing unit 13 to the upper brightness controller 24A. Furthermore, an LED control signal Sig_d_LED for controlling the light emission of LEDs provided in the lower backlight 23B (divided sections C and D) is transmitted from a third video processing unit 113 to the lower brightness controller 24B.

As for other configurations, the display device 100 according to the second modified example of the second embodiment has the same configurations as those of the display device 100 according to the first modified example of the second embodiment. Because of this, the same constituent elements are denoted by the same reference signs and description thereof will be omitted.

That is, in the display device 100 according to the second modified example of the second embodiment, the first video processing unit 13, a second video processing unit 14, the third video processing unit 113, and a fourth video processing unit 114 transmit and/or receive the LED control data between each other. Then, the first video processing unit 13 transmits, to the upper brightness controller 24A, the LED control signal Sig_u_LED including the LED control data corresponding to the divided sections A and B. The third video processing unit 113 transmits, to the lower brightness controller 24B, the LED control signal Sig_d_LED including the LED control data corresponding to the divided sections C and D.

In this manner, in the display device 100 according to the second modified example of the second embodiment, the video processer 10 controls the upper backlight 23A with the LED control signal Sig_u_LED transmitted to the upper brightness controller 24A from the first video processing unit 13. Further, the video processer 10 controls the lower backlight 23B with the LED control signal Sig_d_LED transmitted from the third video processing unit 113 to the lower brightness controller 24B.

The video processer 10 controls the divided video section A with an RGB liquid crystal control signal Sig_CL1 transmitted from the first video processing unit 13 to a first liquid crystal TCON 50. Further, the video processer 10 controls the divided video section B with the RGB liquid crystal control signal Sig_CL2 transmitted from the second video processing unit 14 to the second liquid crystal TCON 51. The video processer 10 controls the divided video section C with an RGB liquid crystal control signal Sig_CL3 transmitted from the third video processing unit 113 to a third liquid crystal TCON 150. The video processer 10 controls the divided video section D with an RGB liquid crystal control signal Sig_CL4 transmitted from the fourth video processing unit 114 to a fourth liquid crystal TCON 151.

In the display device 100 according to the second modified example of the second embodiment, similar to the display device 100 according to the first modified example of the second embodiment, the video processer 10 transmits each of a monochrome liquid crystal control signal Sig_MC1 and a monochrome liquid crystal control signal Sig_MC2 to the monochrome liquid crystal panel 22. That is, the monochrome display control data transmission and/or reception unit 35 of the first video processing unit 13 and the monochrome display control data transmission and/or reception unit 135 of the third video processing unit 113 transmit and/or receive the monochrome display control data between each other. Then, the first video processing unit 13 transmits the monochrome liquid crystal control signal Sig_MC1 including the monochrome display control data for controlling the sections corresponding to the divided video sections A and C in the monochrome liquid crystal panel 22 to the monochrome liquid crystal panel 22 via a first monochrome liquid crystal TCON 52. The monochrome display control data transmission and/or reception unit 45 of the second video processing unit 14 and the monochrome display control data transmission and/or reception unit 145 of the fourth video processing unit 114 transmit and/or receive the monochrome display control data between each other. The second video processing unit 14 transmits the monochrome liquid crystal control signal Sig_MC2 including the monochrome display control data for controlling the sections corresponding to the divided video sections B and D in the monochrome liquid crystal panel 22, to the monochrome liquid crystal panel 22 via a second monochrome liquid crystal TCON 53.

That is, in the display device 100 according to the second modified example of the second embodiment, the patterns of the sections controlled by each of the first video processing unit 13, the second video processing unit 14, the third video processing unit 113, and the fourth video processing unit 114 differ between the liquid crystal panel 21, the monochrome liquid crystal panel 22, and the backlight 23.

Accordingly, in the display device 100 according to the second modified example of the second embodiment, when the display panel 20 is viewed in a plan view, the pattern of the sections controlled by the first video processing unit 13 in the liquid crystal panel 21, the pattern of the sections controlled by the first video processing unit 13 in the monochrome liquid crystal panel 22, and the pattern of the sections controlled by the first video processing unit 13 in the backlight 23 differ from each other.

### Third Modified Example of Second Embodiment

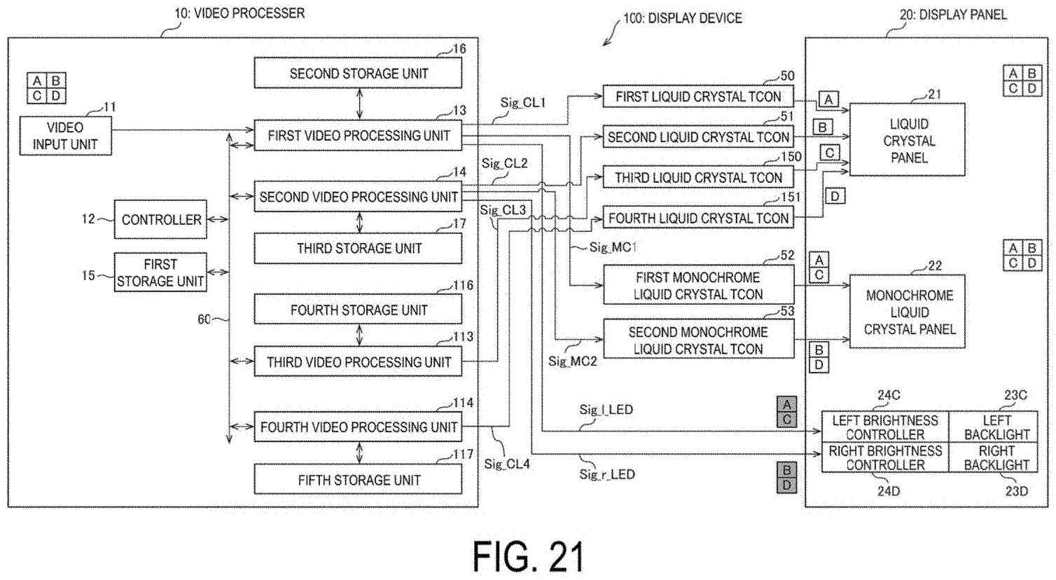

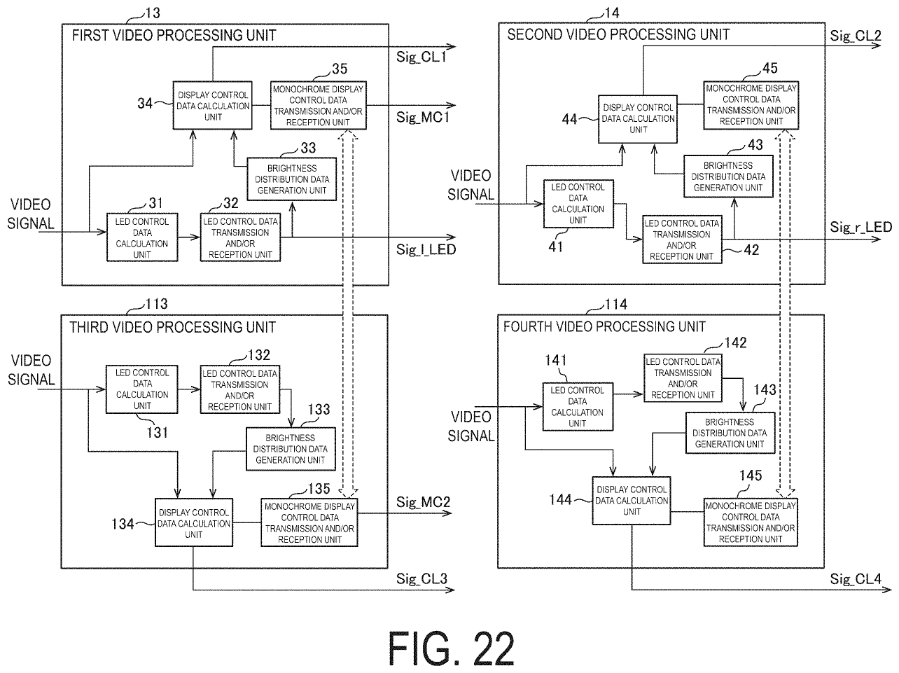

Next, a configuration of a display device 100 according to a third modified example of the second embodiment will be described with reference to FIGS. 21 and 22. FIG. 21 is a block diagram illustrating a configuration of main portions of the display device 100 according to the third modified example of the second embodiment. FIG. 22 is a block diagram illustrating a configuration of main portions of a video processer 10 included in the display device 100 according to the third modified example of the second embodiment. In FIG. 22, the flows of monochrome display control data transmitted and/or received between a first video processing unit 13, a second video processing unit 14, a third video processing unit 113, and a fourth video processing unit 114 are indicated by broken line arrows.

As illustrated in FIG. 21, the display device 100 according to the third modified example of the second embodiment is configured in such a manner that, in the configuration of the display device 100 according to the first modified example of the second embodiment, the backlight 23 is divided into a left backlight 23C and a right backlight 23D, which are individually controlled by the video processer 10.

Specifically, the display device 100 according to the third modified example of the second embodiment is configured to include the left backlight 23C, a left brightness controller 24C configured to control the light emission of LEDs provided in the left backlight 23C, the right backlight 23D, and a right brightness controller 24D configured to control the light emission of LEDs provided in the right backlight 23D in the configuration of the display device 100 according to the first modified example of the second embodiment.

Further, the display device 100 according to the first modified example of the second embodiment is configured in such a manner that the LED control signal Sig_LED including the LED control data for controlling all of the divided sections A, B, C, and D is transmitted from the first video processing unit 13 to the brightness controller 24. In contrast, in the display device 100 according to the third modified example of the second embodiment, an LED control signal Sig_l_LED for controlling the light emission of the LEDs provided in the left backlight 23C (divided sections A and C) is transmitted from a first video processing unit 13 to the left brightness controller 24C. Furthermore, an LED control signal Sig_r_LED for controlling the light emission of the LEDs provided in the right backlight 23D (divided sections B and D) is transmitted from a second video processing unit 14 to the right brightness controller 24D.

As for other configurations, the display device 100 according to the third modified example of the second embodiment has the same configurations as those of the display device 100 according to the first modified example of the second embodiment. Because of this, the same constituent elements are denoted by the same reference signs and description thereof will be omitted.

That is, in the display device 100 according to the third modified example of the second embodiment, the first video processing unit 13, the second video processing unit 14, a third video processing unit 113, and a fourth video processing unit 114 transmit and/or receive the LED control data between each other. Then, the first video processing unit 13 transmits, to the left brightness controller 24C, the LED control signal Sig_1_LED including the LED control data corresponding to the divided sections A and C. The second video processing unit 14 transmits, to the right brightness controller 24D, the LED control signal Sig_r_LED including the LED control data corresponding to the divided sections B and D.

In this manner, in the display device 100 according to the third modified example of the second embodiment, the video processer 10 controls the left backlight 23C with the LED control signal Sig_l_LED transmitted to the left brightness controller 24C from the first video processing unit 13. Further, the video processer 10 controls the right backlight 23D with the LED control signal Sig_r_LED transmitted from the second video processing unit 14 to the right brightness controller 24D.

The video processer 10 controls the divided video section A with an RGB liquid crystal control signal Sig_CL1 transmitted from the first video processing unit 13 to a first liquid crystal TCON 50. Further, the video processer 10 controls the divided video section B with the RGB liquid crystal control signal Sig_CL2 transmitted from the second video processing unit 14 to the second liquid crystal TCON 51. The video processer 10 controls the divided video section C with an RGB liquid crystal control signal Sig_CL3 transmitted from the third video processing unit 113 to a third liquid crystal TCON 150. The video processer 10 controls the divided video section D with an RGB liquid crystal control signal Sig_CL4 transmitted from the fourth video processing unit 114 to a fourth liquid crystal TCON 151.

In the display device 100 according to the third modified example of the second embodiment, similar to the display device 100 according to the first modified example of the second embodiment, the video processer 10 transmits each of a monochrome liquid crystal control signal Sig_MC1 and a monochrome liquid crystal control signal Sig_MC2 to the monochrome liquid crystal panel 22.

That is, as illustrated in FIG. 22, a monochrome display control data transmission and/or reception unit 35 of the first video processing unit 13 and a monochrome display control data transmission and/or reception unit 135 of the third video processing unit 113 transmit and/or receive the monochrome display control data between each other. Then, the first video processing unit 13 transmits the monochrome liquid crystal control signal Sig_MC1 including the monochrome display control data for controlling the sections corresponding to the divided video sections A and C in the monochrome liquid crystal panel 22 to the monochrome liquid crystal panel 22 via a first monochrome liquid crystal TCON 52.

As illustrated in FIG. 22, a monochrome display control data transmission and/or reception unit 45 of the second video processing unit 14 and a monochrome display control data transmission and/or reception unit 145 of the fourth video processing unit 114 transmit and/or receive the monochrome display control data between each other. The second video processing unit 14 transmits the monochrome liquid crystal control signal Sig_MC2 including the monochrome display control data for controlling the sections corresponding to the divided video sections B and D in the monochrome liquid crystal panel 22 to the monochrome liquid crystal panel 22 via a second monochrome liquid crystal TCON 53.

Thus, in the display device 100 according to the third modified example of the second embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 100 according to the third modified example of the second embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

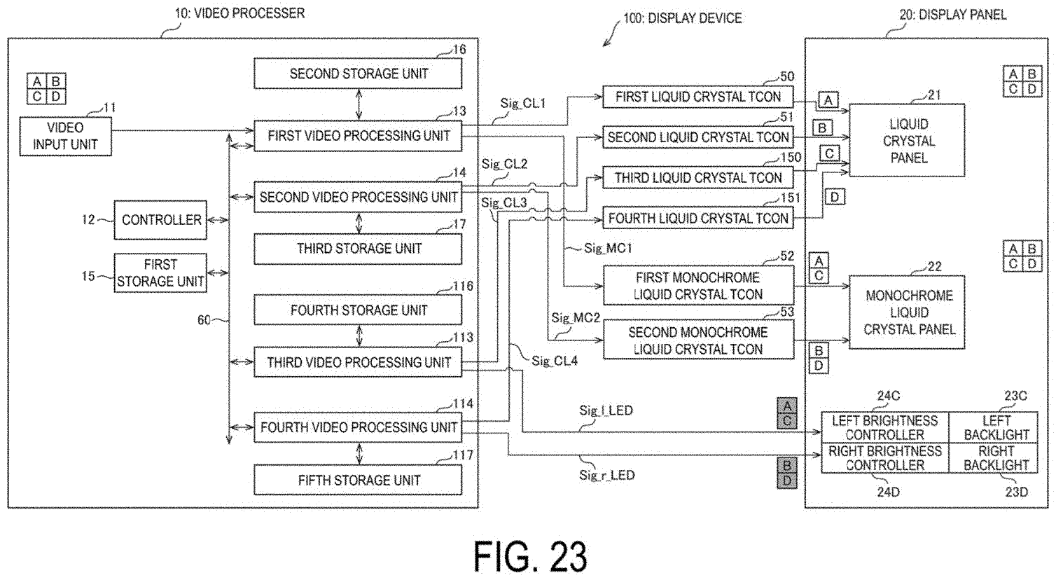

As illustrated in FIG. 21, the video processer 10 has a configuration in which the first video processing unit 13 transmits the LED control signal Sig_l_LED to the left brightness controller 24C, and the second video processing unit 14 transmits the LED control signal Sig_r_LED to the right brightness controller 24D. However, as illustrated in FIG. 23, in place of the first video processing unit 13, the third video processing unit 113 may be configured to transmit the LED control signal Sig_l_LED to the left brightness controller 24C. Alternatively, in place of the second video processing unit 14, the fourth video processing unit 114 may be configured to transmit the LED control signal Sig_r_LED to the right brightness controller 24D. FIG. 23 is a block diagram illustrating a configuration of main portions of the display device 100 according to the third modified example of the second embodiment.

### Fourth Modified Example of Second Embodiment

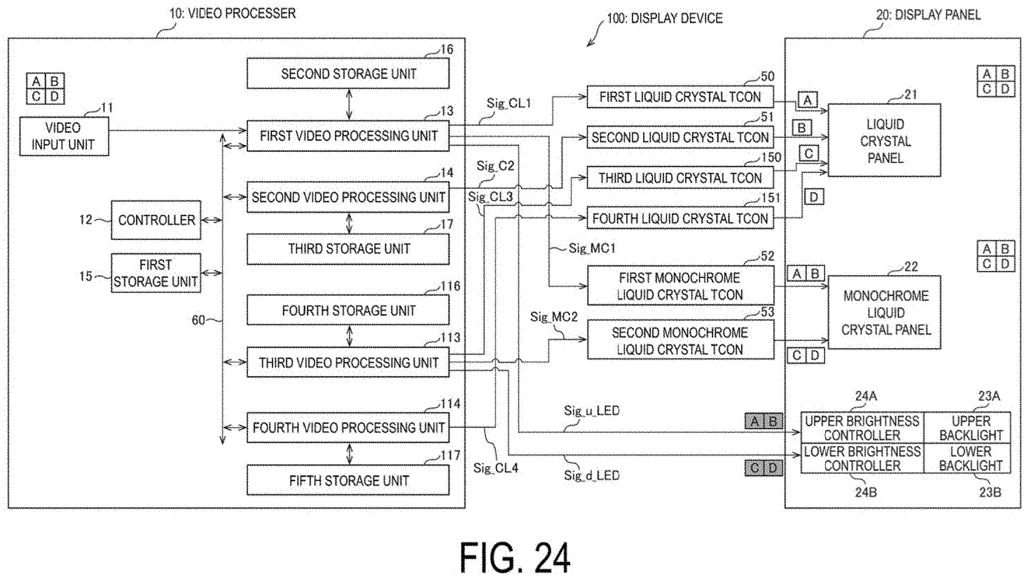

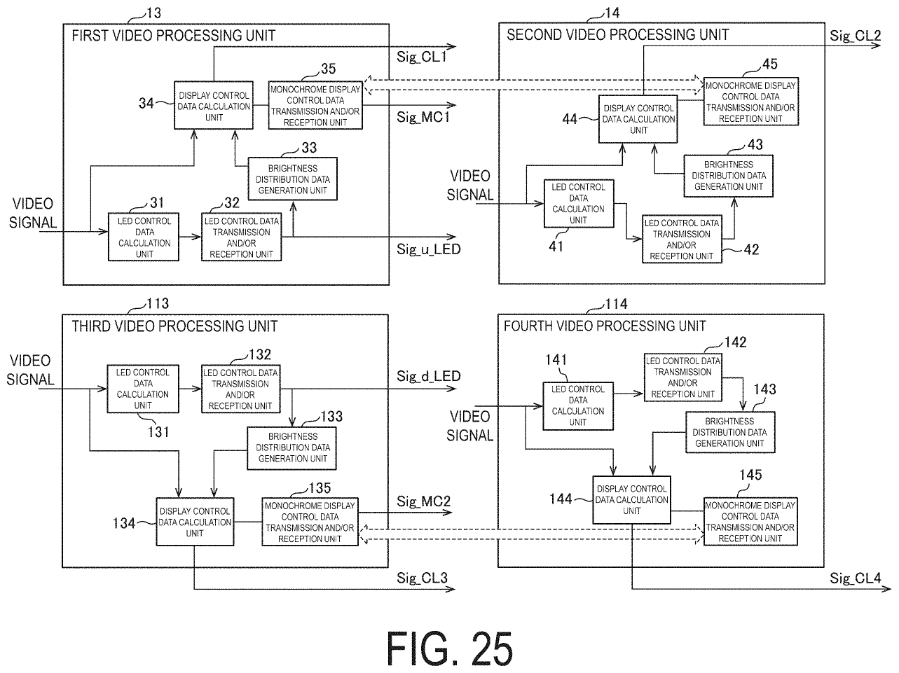

Next, a configuration of a display device 100 according to a fourth modified example of the second embodiment will be described with reference to FIGS. 24 and 25. FIG. 24 is a block diagram illustrating a configuration of main portions of the display device 100 according to the fourth modified example of the second embodiment. FIG. 25 is a block diagram illustrating a configuration of main portions of a video processer 10 included in the display device 100 according to the fourth modified example of the second embodiment. In FIG. 25, in the video processer 10, the configuration of main portions of a first video processing unit 13, a second video processing unit 14, a third video processing unit 113, and a fourth video processing unit 114 is specifically illustrated.

As illustrated in FIG. 24, the display device 100 according to the fourth modified example of the second embodiment has the same configuration as that of the display device 100 according to the second modified example of the second embodiment. However, the display device 100 according to the fourth modified example of the second embodiment differs from the display device 100 according to the second modified example of the second embodiment in that the pattern of sections controlled by the video processer 10 in the monochrome liquid crystal panel 22 is different.

That is, in the display device 100 according to the fourth modified example of the second embodiment, as illustrated in FIG. 25, a monochrome display control data transmission and/or reception unit 35 of the first video processing unit 13 and a monochrome display control data transmission and/or reception unit 45 of the second video processing unit 14 transmit and/or receive the monochrome display control data between each other. Then, the first video processing unit 13 transmits a monochrome liquid crystal control signal Sig_MC1 including the monochrome display control data for controlling the sections corresponding to the divided video sections A and B in the monochrome liquid crystal panel 22 to the monochrome liquid crystal panel 22 via a first monochrome liquid crystal TCON 52.

A monochrome display control data transmission and/or reception unit 135 of the third video processing unit 113 and a monochrome display control data transmission and/or reception unit 145 of the fourth video processing unit 114 transmit and/or receive the monochrome display control data between each other. The third video processing unit 113 transmits a monochrome liquid crystal control signal Sig_MC2 including the monochrome display control data for controlling the sections corresponding to the divided video sections C and D in the monochrome liquid crystal panel 22 to the monochrome liquid crystal panel 22 via a second monochrome liquid crystal TCON 53.

Except for the configuration described above, the display device 100 according to the fourth modified example of the second embodiment is similar to the display device 100 according to the second modified example of the second embodiment. Because of this, the same constituent elements are denoted by the same reference signs and description thereof will be omitted.

That is, in the display device 100 according to the fourth modified example of the second embodiment, the patterns of the sections controlled by each of the first video processing unit 13, the second video processing unit 14, the third video processing unit 113, and the fourth video processing unit 114 differ between the liquid crystal panel 21, the monochrome liquid crystal panel 22, and the backlight 23.

Thus, in the display device 100 according to the fourth modified example of the second embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. In the display device 100 according to the fourth modified example of the second embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

Note that in the display device 100 according to the second embodiment and the display device 100 according to each of the first to third modified examples of the second embodiment, the LED control data transmission and/or reception unit 32, the LED control data transmission and/or reception unit 42, the LED control data transmission and/or reception unit 132, and the LED control data transmission and/or reception unit 142 are configured to transmit and/or receive the LED control data between each other via the controller 12 through the bus 60.

In the display device 100 according to the first modified example of the second embodiment, the monochrome display control data transmission and/or reception unit 35, the monochrome display control data transmission and/or reception unit 45, the monochrome display control transmission and/or reception unit 135, and the monochrome display control data transmission and/or reception unit 145 are configured to transmit and/or receive the monochrome display control data between each other via the controller 12 through the bus 60.

The transmission and/or reception of the LED control data and the monochrome display control data is not limited to the configuration in which the transmission and/or reception thereof is performed via the controller 12 as described above.

For example, as in the display device 100 according to the first embodiment, the first video processing unit 13, second video processing unit 14, third video processing unit 113, and fourth video processing unit 114 may each include a single chip microcomputer, and may be configured to transmit and/or receive the LED control data and the monochrome display control data between the single chip microcomputers through the bus 60.

Alternatively, the first video processing unit 13, second video processing unit 14, third video processing unit 113, and fourth video processing unit 114 may be configured to include a communication interface for data transmission and/or reception through which the above processing units may be communicatively connected to each other. The first video processing unit 13, second video processing unit 14, third video processing unit 113, and fourth video processing unit 114 may be configured to directly transmit and/or receive the LED control data and the monochrome display control data between each other.

As described above, in the display device 100 according to the second embodiment, as illustrated in FIG. 14, the video processer 10 is configured to individually control each of the divided video sections A, B, C, and D with respect to the liquid crystal panel 21. On the other hand, the video processer 10 is configured to control the sections corresponding to all of the divided video sections A, B, C, and D with respect to the monochrome liquid crystal panel 22. Furthermore, the video processer 10 is configured to control the sections corresponding to all of the divided sections A, B, C, and D with respect to the backlight 23 as well.

In other words, in the display device 100 according to the second embodiment, the first video processing unit 13 controls the divided video section A and the second video processing unit 14 controls the divided video section B in the liquid crystal panel 21. The third video processing unit 113 is configured to control the divided video section C, and the fourth video processing unit 114 is configured to control the divided video section D.

In the monochrome liquid crystal panel 22, the first video processing unit 13 is configured to control the sections corresponding to all of the divided video sections A, B, C, and D. In the case where the video processing unit does not transmit the monochrome liquid crystal control signal Sig_MC to the monochrome liquid crystal panel 22, no section in the monochrome liquid crystal panel 22 is controlled by the above video processing unit.

Thus, in the display device 100 according to the second embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22.

The first video processing unit 13 is configured to control all of the divided sections A, B, C, and D in the backlight 23. On the other hand, the second video processing unit 14, the third video processing unit 113, and the fourth video processing unit 114 are configured not to transmit the LED control signal Sig_LED to the backlight 23. In the case where the video processing unit does not transmit the LED control signal Sig_LED to the backlight 23, no section in the backlight 23 is controlled by this video processing unit.

As discussed above, in the display device 100 according to the second embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

In the display device 100 according to the first modified example of the second embodiment, as illustrated in FIG. 17, the video processer 10 is configured to individually control each of the divided video sections A, B, C, and D with respect to the liquid crystal panel 21. The video processer 10 is configured in such a manner as to divide the monochrome liquid crystal panel 22 into sections corresponding to the divided video sections A and C, and sections corresponding to the divided video sections B and D, and as to individually control each of the sections. The video processer 10 is configured to control all of the divided sections A, B, C, and D with respect to the backlight 23.

In other words, in the display device 100 according to the first modified example of the second embodiment, the first video processing unit 13 is configured to control the divided video section A and the second video processing unit 14 is configured to control the divided video section B in the liquid crystal panel 21. The third video processing unit 113 is configured to control the divided video section C, and the fourth video processing unit 114 is configured to control the divided video section D.

In the monochrome liquid crystal panel 22, the first video processing unit 13 is configured to control the sections corresponding to the divided video sections A and C, and the second video processing unit 14 is configured to control the sections corresponding to the divided video sections B and D. The third video processing unit 113 and the fourth video processing unit 114 are each configured not to transmit the monochrome liquid crystal control signal Sig_MC to the monochrome liquid crystal panel 22. Thus, the pattern of the sections controlled by the first video processing unit 13 in the monochrome liquid crystal panel 22 is different from the pattern of the sections controlled by the first video processing unit 13 in the liquid crystal panel 21.

The first video processing unit 13 is configured to control all of the divided sections A, B, C, and D in the backlight 23. On the other hand, the second video processing unit 14, the third video processing unit 113, and the fourth video processing unit 114 are configured not to transmit the LED control signal Sig_LED to the backlight 23.

As described above, in the display device 100 according to the first modified example of the second embodiment, when the display panel 20 is viewed in a plan view, the pattern of the sections controlled by the first video processing unit 13 in the liquid crystal panel 21, the pattern of the sections controlled by the first video processing unit 13 in the monochrome liquid crystal panel 22, and the pattern of the sections controlled by the first video processing unit 13 in the backlight 23 differ from each other.

In the display device 100 according to the second modified example of the second embodiment, as illustrated in FIG. 20, the video processer 10 is configured to individually control each of the divided video sections A, B, C, and D with respect to the liquid crystal panel 21. On the other hand, the video processer 10 is configured in such a manner as to divide the monochrome liquid crystal panel 22 into sections corresponding to the divided video sections A and C, and sections corresponding to the divided video sections B and D, and as to individually control each of the sections. Further, the video processer 10 is configured in such a manner as to divide the backlight 23 into the upper backlight 23A (divided sections A and B) and the lower backlight 23B (divided sections C and D), and as to individually control each of the sections.

In other words, in the display device 100 according to the second modified example of the second embodiment, the first video processing unit 13 is configured to control the divided video section A and the second video processing unit 14 is configured to control the divided video section B in the liquid crystal panel 21. The third video processing unit 113 is configured to control the divided video section C and the fourth video processing unit 114 is configured to control the divided video section D in the liquid crystal panel 21.

In the monochrome liquid crystal panel 22, the first video processing unit 13 is configured to control the sections corresponding to the divided video sections A and C, and the second video processing unit 14 is configured to control the sections corresponding to the divided video sections B and D. The third video processing unit 113 and the fourth video processing unit 114 are configured not to transmit the monochrome liquid crystal control signal Sig_MC to the monochrome liquid crystal panel 22.

Further, in the backlight 23, the first video processing unit 13 is configured to control the upper backlight 23A (divided sections A and B), and the third video processing unit 113 is configured to control the lower backlight 23B (divided sections C and D).

As described above, in the display device 100 according to the second modified example of the second embodiment, when the display panel 20 is viewed in a plan view, the pattern of the sections controlled by the first video processing unit 13 in the liquid crystal panel 21, the pattern of the sections controlled by the first video processing unit 13 in the monochrome liquid crystal panel 22, and the pattern of the sections controlled by the first video processing unit 13 in the backlight 23 differ from each other.

In the display device 100 according to the third modified example of the second embodiment, as illustrated in FIG. 21, the video processer 10 is configured to individually control each of the divided video sections A, B, C, and D with respect to the liquid crystal panel 21. On the other hand, the video processer 10 is configured in such a manner as to divide the monochrome liquid crystal panel 22 into sections corresponding to the divided video sections A and C, and sections corresponding to the divided video sections B and D, and as to individually control each of the sections. Further, the video processer 10 is configured in such a manner as to divide the backlight 23 into the left backlight 23C (divided sections A and C) and the right backlight 23D (divided sections B and D), and as to individually control each of the sections.

In other words, in the display device 100 according to the third modified example of the second embodiment, the first video processing unit 13 is configured to control the divided video section A and the second video processing unit 14 is configured to control the divided video section B in the liquid crystal panel 21. The third video processing unit 113 is configured to control the divided video section C and the fourth video processing unit 114 is configured to control the divided video section D in the liquid crystal panel 21.

In the monochrome liquid crystal panel 22, the first video processing unit 13 is configured to control the sections corresponding to the divided video sections A and C, and the second video processing unit 14 is configured to control the sections corresponding to the divided video sections B and D. Further, the third video processing unit 113 and the fourth video processing unit 114 are configured not to transmit the monochrome liquid crystal control signal Sig_MC to the monochrome liquid crystal panel 22.

In the backlight 23, the first video processing unit 13 is configured to control the left backlight 23C (divided sections A and C), and the second video processing unit 14 is configured to control the right backlight 23D (divided sections B and D).

Thus, in the display device 100 according to the third modified example of the second embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. Further, in the display device 100 according to the third modified example of the second embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

In the display device 100 according to the fourth modified example of the second embodiment, as illustrated in FIG. 24, the video processer 10 is configured to individually control each of the divided video sections A, B, C, and D with respect to the liquid crystal panel 21. On the other hand, the video processer 10 is configured in such a manner as to divide the monochrome liquid crystal panel 22 into sections corresponding to the divided video sections A and B, and sections corresponding to the divided video sections C and D, and as to control each of the sections. Further, the backlight 23 is divided into the upper backlight 23A (divided sections A and B) and the lower backlight 23B (divided sections C and D), and each of the sections is controlled.

In other words, in the display device 100 according to the fourth modified example of the second embodiment, the first video processing unit 13 is configured to control the divided video section A and the second video processing unit 14 is configured to control the divided video section B in the liquid crystal panel 21. The third video processing unit 113 is configured to control the divided video section C and the fourth video processing unit 114 is configured to control the divided video section D in the liquid crystal panel 21.

In the monochrome liquid crystal panel 22, the first video processing unit 13 is configured to control the sections corresponding to the divided video sections A and B, and the third video processing unit 113 is configured to control the sections corresponding to the divided video sections C and D. The second video processing unit 14 and the fourth video processing unit 114 are configured not to transmit the monochrome liquid crystal control signal Sig_MC to the monochrome liquid crystal panel 22.

Further, in the backlight 23, the first video processing unit 13 is configured to control the upper backlight 23A (divided sections A and B), and the third video processing unit 113 is configured to control the lower backlight 23B (divided sections C and D).

Thus, in the display device 100 according to the fourth modified example of the second embodiment, when the display panel 20 is viewed in a plan view, the pattern of the sections controlled by the first video processing unit 13 in the liquid crystal panel 21 is different from the pattern of the sections controlled by the first video processing unit 13 in the monochrome liquid crystal panel 22. In the display device 100 according to the fourth modified example of the second embodiment, when the display panel 20 is viewed in a plan view, the pattern of the sections controlled by the first video processing unit 13 in the liquid crystal panel 21 is different from the pattern of the sections controlled by the first video processing unit 13 in the backlight 23.

As described above, in the display device 100 according to the second embodiment and the display device 100 according to each of the first to fourth modified examples of the second embodiment, when at least two units of the liquid crystal panel 21, the monochrome liquid crystal panel 22, and the backlight 23 are compared with each other, the pattern of the sections controlled by the first video processing unit 13, the pattern of the sections controlled by the second video processing unit 14, the pattern of the sections controlled by the third video processing unit 113, and the pattern of the sections controlled by the fourth video processing unit 114 are different from each other.

Thus, in the display device 100, the substrate configured to control each of the liquid crystal panel 21, the monochrome liquid crystal panel 22, and the backlight 23 may be appropriately arranged in such a manner that the terminal positions, the wiring lines, and the like of the liquid crystal panel 21, the monochrome liquid crystal panel 22, and the backlight 23 do not overlap with one another. Further, there is a possibility that the brightness control substrate, the TCON substrate, or the like that is used in the display device 1000 according to the comparative example may be used; in such a case, it is unnecessary to newly design a substrate, and is possible to reduce the manufacturing cost.

The constituent elements included in the video processer 10 according to the first and second embodiments, particularly the constituent elements included in the first to fourth video processing units 13, 14, 113, and 114 may be implemented by logic circuits (hardware) formed in an integrated circuit (IC chip) or the like, or may be implemented by software. In the latter case, the constituent elements included in the first to fourth video processing units 13, 14, 113, and 114 may be implemented in such a manner that a program stored in the first storage unit 15 is read out onto a memory (not illustrated) or the like and executed by the controller 12, which may be achieved by a CPU or the like.

In the first embodiment, the first video processing unit 13 and the second video processing unit 14 may be configured by a single integrated circuit, or may each be configured by a different integrated circuit. In the latter case, two integrated circuits that are used to process a lower resolution video may be used in the video processer 10 according to the first embodiment. Likewise, in the second embodiment, the first video processing unit 13, second video processing unit 14, third video processing unit 113, and fourth video processing unit 114 may be configured by a single integrated circuit, or may each be configured by a different integrated circuit. In the latter case, four integrated circuits that are used to process a lower resolution video may be used in the video processer 10 according to the second embodiment. This makes it possible to reduce the costs of designing and manufacturing a new integrated circuit.

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in each of the embodiments.

While there have been described what are at present considered to be certain embodiments of the application, it will be understood that various modifications may be made thereto, and it is intended that the appended claim cover all such modifications as fall within the true spirit and scope of the application.

1. A video processer configured to control a display panel including a first liquid crystal panel, a second liquid crystal panel, and a backlight disposed facing one another, the video processer comprising:
a plurality of video processing units configured to control the first liquid crystal panel, the second liquid crystal panel, and the backlight,
wherein the plurality of video processing units control at least the first liquid crystal panel among the first liquid crystal panel, the second liquid crystal panel, and the backlight, by dividing the first liquid crystal panel into a plurality of sections, and
in a case where at least two units of the first liquid crystal panel, the second liquid crystal panel, and the backlight are compared with each other, patterns of the sections controlled by the plurality of video processing units are different from each other.

2. The video processer according to claim 1,
wherein in the backlight, a pattern of the sections controlled by one of the plurality of video processing units refers to the whole backlight.

3. The video processer according to claim 1,
wherein the plurality of video processing units divide the backlight into a plurality of sections to control the backlight, and
in a case where the first liquid crystal panel and the backlight are compared with each other, the patterns of the sections controlled by the plurality of video processing units are different from each other.

4. The video processer according to claim 1,
wherein in the second liquid crystal panel, a pattern of the sections controlled by one of the plurality of video processing units refers to the whole second liquid crystal panel.

5. The video processer according to claim 1,
wherein the plurality of video processing units divide the second liquid crystal panel into a plurality of sections to control the second liquid crystal panel, and
in a case where the first liquid crystal panel and the second liquid crystal panel are compared with each other, the patterns of the sections controlled by the plurality of video processing units are identical.

6. The video processer according to claim 1,
wherein the plurality of video processing units divide the second liquid crystal panel into a plurality of sections to control the second liquid crystal panel, and
in a case where the first liquid crystal panel and the second liquid crystal panel are compared with each other, the patterns of the sections controlled by the plurality of video processing units are different from each other.

7. The video processer according to claim 1,
wherein the second liquid crystal panel is superimposed on the backlight, and the first liquid crystal panel is superimposed on the second liquid crystal panel,
the plurality of video processing units include a first video processing unit configured to control a first section in the first liquid crystal panel, and a second video processing unit configured to control a second section in the first liquid crystal panel,
at least one of the first video processing unit and the second video processing unit controls the second liquid crystal panel,
at least one of the first video processing unit and the second video processing unit controls the backlight, and
at least one of conditions (i) and (ii) is satisfied, the conditions (i) and (ii) being,
(i) in a plan view of the display panel, a pattern of the sections controlled by the first video processing unit in the second liquid crystal panel differs from a pattern of the first section, and
(ii) in the plan view of the display panel, a pattern of the sections controlled by the first video processing unit in the backlight differs from the pattern of the first section.

8. The video processer according to claim 7,
wherein in the backlight, the pattern of the sections controlled by the first video processing unit refers to the whole backlight.

9. The video processer according to claim 7,
wherein in the backlight, a pattern of the sections controlled by the second video processing unit refers to the whole backlight.

10. The video processer according to claim 7,
wherein in the backlight, the sections controlled by the first video processing unit differ from the sections controlled by the second video processing unit, and
in the plan view of the display panel, the pattern of the sections controlled by the first video processing unit in the backlight is different from the pattern of the first section.

11. The video processer according to claim 1,
wherein the second liquid crystal panel is superimposed on the backlight, and the first liquid crystal panel is superimposed on the second liquid crystal panel,
the plurality of video processing units include a first video processing unit configured to control a first section in the first liquid crystal panel, a second video processing unit configured to control a second section in the first liquid crystal panel, and a third video processing unit configured to control a third section in the first liquid crystal panel,
at least one of the first video processing unit, the second video processing unit, and the third video processing unit controls the second liquid crystal panel,
the third video processing unit controls the whole backlight or one of sections obtained by dividing the backlight into a plurality of sections, and
at least one of conditions (iii) and (iv) is satisfied, the conditions (iii) and (iv) being,
(iii) in a plan view of the display panel, a pattern of the sections controlled by the first video processing unit in the second liquid crystal panel differs from a pattern of the first section, and
(iv) in the plan view of the display panel, a pattern of the sections controlled by the first video processing unit in the backlight differs from the pattern of the first section.

12. The video processer according to claim 7,
wherein, in the plan view of the display panel, the pattern of the sections controlled by the first video processing unit in the first liquid crystal panel is identical to the pattern of the sections controlled by the first video processing unit in the second liquid crystal panel.

13. The video processer according to claim 7,
wherein in the second liquid crystal panel, the pattern of the sections controlled by the first video processing unit refers to the whole second liquid crystal panel.

14. The video processer according to claim 7,
wherein the first video processing unit and the second video processing unit mutually control different sections in the second liquid crystal panel, and
in the plan view of the display device, the pattern of the sections controlled by the first video processing unit in the second liquid crystal panel differs from the pattern of the first section.

15. The video processer according to claim 7,
wherein, in the plan view of the display panel, the first video processing unit generates second liquid crystal panel first control data for controlling a range to become a pattern of a section identical to the first section in the second liquid crystal panel,
in the plan view of the display panel, the second video processing unit generates second liquid crystal panel second control data for controlling a range to become a pattern of a section identical to the second section in the second liquid crystal panel, and
the first video processing unit and the second video processing unit transmit and/or receive the second liquid crystal panel first control data and the second liquid crystal panel second control data between each other.

16. The video processer according to claim 7,
wherein, in the plan view of the display panel, the first video processing unit generates backlight first control data for controlling a range to become a pattern of a section identical to the first section in the backlight,
in the plan view of the display panel, the second video processing unit generates backlight second control data for controlling a range to become a pattern of a section identical to the second section in the backlight, and
the first video processing unit and the second video processing unit transmit and/or receive the backlight first control data and the backlight second control data between each other.

17. The video processer according to claim 1,
wherein the plurality of video processing units are each constituted by a different integrated circuit.

18. A display device comprising:
a display panel including a backlight having a plurality of light-emitting regions, a second liquid crystal panel superimposed on the backlight, and a first liquid crystal panel superimposed on the second liquid crystal panel; and
the video processer according to claim 1.

19. The display device according to claim 18,
wherein a resolution of the first liquid crystal panel is higher than a resolution of the second liquid crystal panel.

20. The display device according to claim 18,
wherein the first liquid crystal panel is a color liquid crystal panel, and the second liquid crystal panel is a monochrome liquid crystal panel.
